(19) United States
(12) Patent Application Publication
(10) Pub. No.: US 2025/0390167 A1
(43) Pub. Date: Dec. 25, 2025

(54) SYSTEMS AND METHODS FOR CONTEXTUALLY CONTROLLING VEHICLE COMPONENTS BASED ON AN OCCUPANT'S GAZE

(71) Applicant: Adeia Guides Inc., San Jose, CA (US)

(72) Inventors: VasanthRaj Rajanna, Bengaluru (IN); Reda Harb, Tampa, FL (US); Kyle Beckemeyer, Park Ridge, IL (US)

(21) Appl. No.: 18/752,052

(22) Filed: Jun. 24, 2024

(51) Int. Cl. G06F 3/01; B60R 16/037

(52) U.S. Cl. CPC G06F 3/013; B60R 16/0373

(57) ABSTRACT

Systems and methods are provided for contextually controlling vehicle components based on the gaze of a vehicle occupant. The gaze of a vehicle occupant is monitored using one or more optical sensors and control circuitry to identify a first settled gaze. The gaze context is determined contemporaneously with the first settled gaze using one or more context sensors and the control circuitry. A vehicle component is identified based on the first settled gaze and the gaze context. A control signal is then generated at input/output circuitry to control the vehicle component, the control signal being based on the identified vehicle component and the first gaze context.

### BACKGROUND

This disclosure is generally directed to systems and methods for using a vehicle occupant's gaze in conjunction with contemporaneous gaze context to control vehicle components. By combining the direction or object of the vehicle occupant's gaze with the gaze context, the intent of the occupant's gaze may be determined. And with the intent of the occupant's gaze determined, vehicle components may be controlled in accordance with the intent and/or desires of the vehicle occupant.

### SUMMARY

Vehicles today typically include a variety of control mechanisms for enabling a vehicle occupant to control different vehicle components. Traditionally, vehicle occupants have interacted with physical buttons and knobs within vehicles. These manual interfaces, however, can be distracting and tedious, particularly for vehicle occupants not familiar with the vehicle in question. Moreover, such distractions can be especially problematic for a driver. Increasingly, touch-sensitive displays have become more prevalent in vehicles and have significantly (but not entirely) replaced physical buttons and knobs. Touch-sensitive displays, however, can be even more cumbersome than physical buttons and knobs for the uninitiated vehicle occupant. A vehicle occupant may be presented with numerous menus and interfaces, many of which are difficult to navigate when trying to find a desired sub-system or set of controls. Further, because touch-sensitive displays typically eliminate tactile feedback, the ability to blindly use a touch-sensitive display interface is greatly diminished when compared to physical buttons and knobs. This diminished ability can especially affect the driver of a vehicle, who ideally keeps their eyes on the road as much as possible.

Voice command systems have also been implemented in vehicles, and for numerous reasons voice command systems may also be undesirable. Vehicle occupants, particularly those not accustomed to the vehicle, may not be familiar with the voice command set for which the vehicle is configured. Even for those vehicle occupants familiar with the voice command set, voice commands can be difficult for those with a dialect, accent, or speech impediment. In some instances, a voice command system can be trained to particular vehicle occupants. Training, however, tends to only benefit the owner/driver of the vehicle, as infrequent vehicle occupants are likely to have no chance to train the voice command system to understand their voices.

More recently, attempts have been made to use a vehicle occupant's gaze as a tool for interacting with systems in a vehicle. So far, the use of gaze has been underwhelming at best, as the ability for gaze to control vehicle systems seems limited to the systems with user interface elements displayed on the touch-sensitive display. And, while further attempts have been made to enhance the capabilities of using gaze to control vehicle components and systems, nothing yet appears to be working well enough to catch on.

A need therefore exists to facilitate interactions between a vehicle occupant and the components and systems of a vehicle. To address this need and overcome the existing shortcomings, systems and methods that utilize the gaze of a vehicle occupant in combination with a contemporaneous gaze context to control vehicle components and systems are presented. While the gaze of a vehicle occupant can indicate, sometimes directly, the component or system to be controlled, the gaze alone often cannot indicate how the vehicle component or system should be controlled. Merely gazing at the volume indicator interface element does not tell the sound system whether to turn the volume up, turn the volume down, or leave the volume right where it is. However, by considering the gaze along with contemporaneous gaze context, an understanding of the gaze, particularly the intent of the vehicle occupant, may start to become clear. When a vehicle occupant gazes at the volume indicator interface element and the gaze context is that the vehicle occupant is trying to speak, then the intent of the vehicle occupant may become clear to a gaze-monitoring system: the vehicle occupant wants the volume of the music turned down so they can speak without feeling like they are yelling.

In furtherance of identifying the intent of the vehicle occupant that is associated with the gaze, the systems and methods descried herein monitor the gaze of a vehicle occupant and determine a contemporaneous gaze context associated with the gaze settling on a vehicle component or in a particular direction. The settled gaze in combination with the contemporaneous gaze context, may aid the gaze-monitoring system in identifying the intent of the vehicle occupant. And, based on the identified intent, the gaze-monitoring system may control vehicle components and systems in a manner that is responsive to the intent of the vehicle occupant. This is especially true because the gaze of a vehicle occupant does not always clearly indicate what components or systems of a vehicle the vehicle occupant would like to control. A gaze at one of the air vents, with nothing more, does not tell the vehicle system that the vehicle occupant thinks the vehicle cabin is too warm. However, that same gaze combined with the contemporaneous gaze context that the ambient air near the vehicle occupant is warmer than the ambient air in other parts of the vehicle can inform the gaze-monitoring system that the set point temperature of the climate control system should be turned down at least a couple of degrees.

The ability to identify the vehicle component to be controlled based on the gaze and the gaze context, and to determine how to control the identified vehicle component based on the gaze context presents an advantage of the systems and methods described herein. In such systems and methods, one or more optical sensors may monitor the gaze of a vehicle occupant, and one or more context sensors may monitor the contemporaneous gaze context. The context sensors may monitor conditions, events, or things both inside the cabin of the vehicle and external to the vehicle. The gaze context may also be determined from the status of systems associated with the vehicle and/or with profile information associated with a vehicle occupant. Through the gaze context, in combination with the gaze of the vehicle occupant, the systems and methods described herein can infer the intent of the vehicle occupant for purposes of identifying which vehicle component or system to control and how to control the identified component or system. The combination of the gaze and the gaze context may therefore be a convenient and satisfying way for vehicle occupants to control vehicle components and systems.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale. The figures include:

FIG. 1 shows an exemplary environment in which vehicle components may be contextually controlled based on an occupant's gaze, in accordance with embodiments of the disclosure;

FIG. 2 shows an exemplary vehicle cabin in which vehicle components may be contextually controlled based on an occupant's gaze, in accordance with embodiments of the disclosure;

FIG. 3 shows an exemplary system for contextually controlling vehicle components based on an occupant's gaze, in accordance with embodiments of the disclosure;

FIG. 4 is a flowchart showing an exemplary process for contextually controlling vehicle components based on an occupant's gaze, in accordance with embodiments of the disclosure;

FIG. 5 is a flowchart showing an exemplary process for determining the presence of and identifying a vehicle occupant, in accordance with embodiments of the disclosure;

FIG. 6 is a flowchart showing an exemplary process for generating a profile for a vehicle occupant, in accordance with embodiments of the disclosure;

FIG. 7 is a flowchart showing an exemplary process for contextually controlling vehicle components when contextual control signals are received from more than one occupant within a vehicle, in accordance with embodiments of the disclosure;

FIG. 8 is a flowchart showing an exemplary a machine learning process that may be used to train a system for contextually controlling vehicle components based on an occupant's gaze, in accordance with embodiments of the disclosure; and

FIG. 9 is a flowchart showing an exemplary process for calibrating gaze tracking in a vehicle, in accordance with embodiments of the disclosure; and

FIG. 10 is an example of an illustrative system implementing equipment, in accordance with embodiments of the disclosure.

### DETAILED DESCRIPTION

Systems and methods are described herein for contextually controlling vehicle components based on the gaze of an occupant. The systems and methods may monitor the gaze of a vehicle occupant, whether the vehicle occupant is the driver of the vehicle or a passenger, to identify a settled gaze. The systems and methods also determine a gaze context occurring contemporaneously with the settled gaze and identifies a vehicle component based on the settled gaze, such that the vehicle component may then be controlled based on the gaze context.

As described herein, the term “vehicle” and its variants refer to any mode of transportation that is used for transporting people. Road vehicles are an example of a mode of transportation, and road vehicles may include automobiles, sports utility vehicles (SUVs), light trucks, heavy duty trucks, vans, minivans, buses, among others. Other modes of transportation may include air transportation, sea transportation, and rail transportation. The systems and methods for contextually controlling vehicle components based on an occupant's gaze are described herein as being implemented into a passenger vehicle. Such an implementation into a passenger vehicle is understood to be an example only and is intended to be non-limiting.

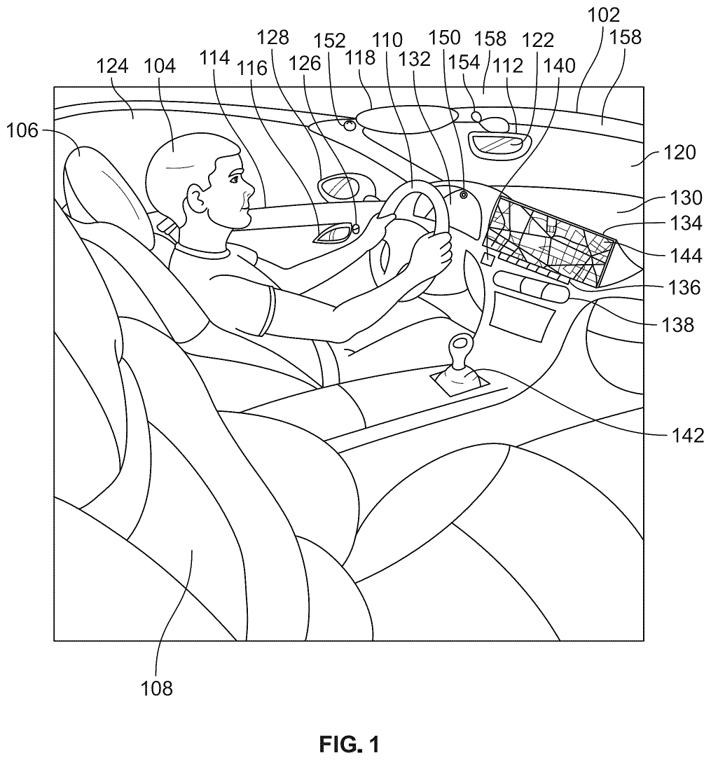

Turning in detail to the drawings, FIG. 1 illustrates a vehicle 102 which includes a gaze-monitoring system for contextually controlling vehicle components based on an occupant's gaze. A vehicle occupant 104 seated in the driver seat 106, and the passenger seat 108 is empty. As used herein the vehicle occupant 104 seated in the driver seat 106 may be referred to as the “driver,” and the vehicle occupant seated in the passenger seat 108 may be referred to as the “passenger.” The vehicle occupant 104 has their hands on the steering wheel 110 and is driving the vehicle 102.

The vehicle 102 is constructed from vehicle components, many of which are common amongst different types of vehicles. Some of the vehicle components are passive vehicle components, and some vehicle components are active vehicle components, and still other vehicle components may be combination vehicle components having both passive vehicle component qualities and active vehicle component qualities. A passive vehicle component is a vehicle component which remains in a state until acted upon by a vehicle occupant. Some passive vehicle components may be constructed to remain stationary and unchanged (e.g., the dashboard), while other passive vehicle components may be changed or operated by a vehicle occupant. Examples of passive vehicle components may include the rear-view mirror mount 112 (which may be moved only by application of directional pressure from the vehicle occupant 104), the driver door 114 (which may be opened only by manual actuation of the driver door handle 116), the sun visor 118 (which may be moved only by application of directional pressure from the vehicle occupant 104), the windshield 120 (which itself may be constructed to remain unchanged and stationary), analogue buttons and knobs, and the like. In some vehicles, certain passive vehicle components may be implemented as active vehicle components or combination vehicle components.

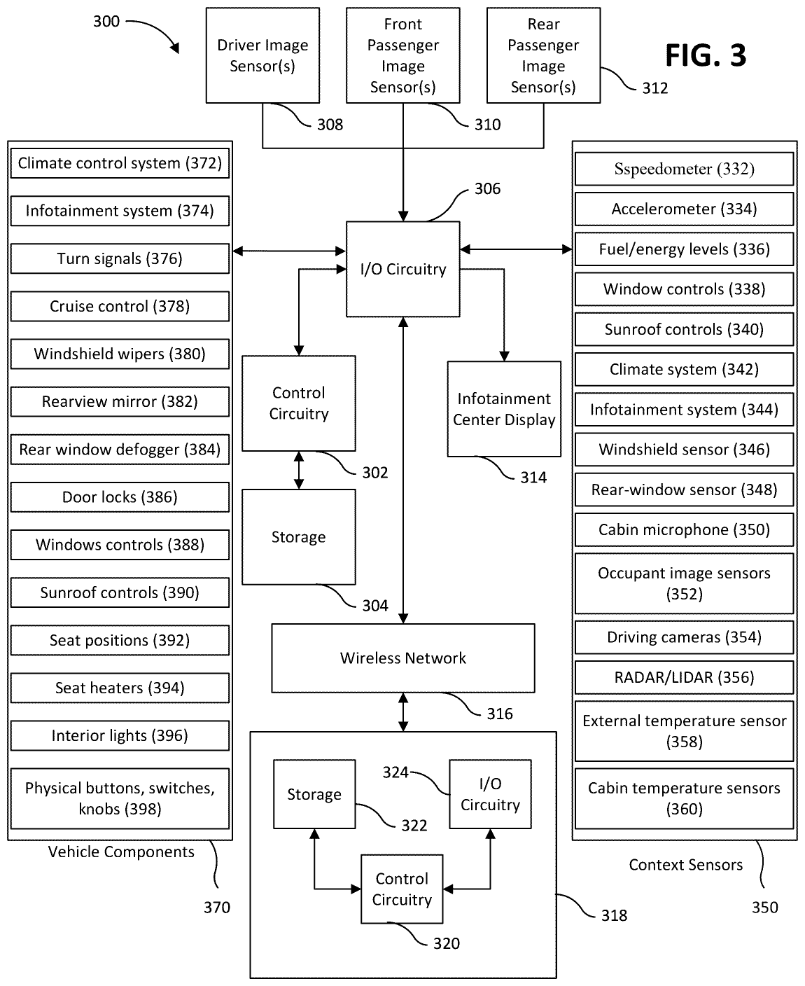

An active vehicle component is a vehicle component which may be operated or actuated by a control signal from control circuitry (see FIG. 3) in response to received input or predetermined conditions, with the control circuitry integrated as part of the vehicle 102. Examples of active vehicle components may include the rear-view mirror 122 (which may have the reflectance changed in response to detected incident light levels), climate control systems (which heat/cool the vehicle cabin in response to detected cabin temperature), windshield wipers (which in some vehicles the frequency of wiping is determined by the amount of rain detected on the windshield), the driver window 124 (in which a window actuator, internal to the driver door 114, may be controlled in response to the vehicle occupant 104 actuating the window switch 126), and the like. In some vehicles, certain active vehicle components may be implemented as passive vehicle components (e.g., for a window, the rocker switch directly controls the window actuator). Also, in some vehicles, certain active vehicle components may be implemented as combination vehicle components.

A combination vehicle component is a vehicle component which may be operated or actuated directly by an occupant or directly by the control circuitry using a control signal. Examples of combination vehicle components may include door locks (which in some vehicles may be directly actuated by a vehicle occupant and actuated by control circuitry in response to speed of the vehicle and/or the transmission of the vehicle being placed into ‘Park’), a rear compartment hatch (which in some vehicles may be manually actuated by a latch handle and/or a key and may also be actuated by control circuitry in response to a pushbutton switch in the vehicle cabin), a sound/entertainment system (which in some vehicles the volume may be directly controlled using a knob by a vehicle occupant and the volume may be controlled by control circuitry in response to vehicle cabin noise and/or if the driver receives a phone call), the driver seat 106 (the position of which may be passive and controlled by the driver using seat actuator switches, and an included seat heater may be actively controlled by control circuitry in response to a differential between a driver seat temperature and a cabin temperature), and the like. In some vehicles, certain combination vehicle components may be implemented as active vehicle components or passive vehicle components.

Whether a vehicle component is passive vehicle component, an active vehicle component, or a combination vehicle component is not intended to be limiting. Rather, the distinction is helpful to understand which vehicle components may and may not be controlled by the gaze-monitoring system and processes discussed herein. The gaze-monitoring system cannot control a passive vehicle component, but a vehicle occupant may gaze at a passive vehicle component and have the intent to control an associated active vehicle component (e.g., staring at an air vent may indicate the intent to control the climate control system). Similarly, a vehicle occupant gazing at an active vehicle component, or a combination vehicle component may indicate an intent to control the component at which the gaze is directed. However, this too depends on the gaze context. A vehicle occupant may gaze at the infotainment center display and have the intent to control the audio system, and this intent may be determined based on the gaze context. Similarly, the gaze context may tell the gaze-monitoring system that the vehicle occupant is gazing at the vehicle component to be controlled, such as the navigation system when the infotainment center display is displaying a map and a cabin microphone hears the passenger saying, “Where are we going again?” Gaze context may thus aid in identifying the vehicle component to be controlled in response to the gaze of a vehicle occupant and in determining how to control the identified vehicle component.

The vehicle 102 is shown with several other vehicle components, including a driver side mirror 128, a dashboard 130, a driver display 132 for displaying certain vehicle status information including road speed, an infotainment center display 134 for providing vehicle occupants with a graphical user interface (GUI) to control over vehicle systems, programmable buttons 136 for interacting with the infotainment center display 134, cabin climate controls 138, hazard lights control 140, and vehicle power control 142. In vehicles which include an internal combustion engine, the vehicle power control 142 may be a transmission control. In some electric vehicles, the vehicle power control may be omitted in favor of managing the vehicle power control through the GUI.

The vehicle 102 may also include other vehicle components that are accessible and/or viewable from within the vehicle cabin, including, but not limited to: an accelerator pedal, a brake pedal, a transmission control (for a vehicle that includes a transmission), a heads-up driver display, cabin lights, windshield wipers, windshield wiper controls, driving light controls, parking light controls, turn signal control, cruise control controls, side view mirror controls, driver seat position controls, passenger seat position controls, sunroof controls, convertible top controls, and device charging & interface ports, among others. In some embodiments, every part of the vehicle 102 may be considered a vehicle component for purposes of monitoring the gaze of the vehicle occupant 104. In some embodiments, the scope of what is and is not a vehicle component, for purposes of monitoring a vehicle occupant's gaze, may be pre-defined. In some embodiments, the scope of what is and is not a vehicle component, for purposes of monitoring a vehicle occupant's gaze, may start as being pre-defined and thereafter be enlarged based on the usage, habits, and/or preferences of the vehicle occupant (which may, in many instances, be the vehicle owner or regular operator).

The vehicle 102 also includes several image sensors 150, 152, 154 integrated as part of the gaze-monitoring system. The image sensors 150, 152, 154 are located within the cabin for monitoring the gaze of one or more vehicle occupants. Some embodiments may include more image sensors than shown in FIG. 1. Each of the image sensors 150, 152, 154 may operate in the visible light spectrum. In some embodiments, one or more of the image sensors 150, 152, 154 may operate in the infrared light spectrum. In some embodiments, one or more of the image sensors 150, 152, 154 may operate across multiple light spectrums. In some embodiments, at least one of the image sensors 150, 152, 154 is a multi-spectral image sensor, as this may better enable monitoring the gaze of a vehicle occupant during both daytime and nighttime. In some embodiments, at least one of the image sensors 150, 152, 154 operates in the visible light spectrum and at least one of the image sensors 150, 152, 154 operates in the infrared light spectrum to enable monitoring the gaze of a vehicle occupant during both daytime and nighttime. The image sensor 150 is located adjacent the driver display 132 to provide a face-forward view of the vehicle occupant 104 in the driver seat 106 while the vehicle 102 is being driven. The image sensor 150 may be continuously directed at the vehicle occupant 104 in the driver seat 106. The other two image sensors 152, 154 are positioned along the upper windshield frame 158 to provide additional views of the eyes of the vehicle occupant 104. The image sensors 152, 154 may aid in monitoring the gaze of the vehicle occupant 104 when the vehicle occupant 104 tilts and/or turns their head to look in directions other than straight ahead during driving.

One or more of the image sensors 150, 152, 154 may be part of a gaze-monitoring system that monitors the gaze of the vehicle occupant 104 by tracking eye movements of the vehicle occupant 104, generating eye tracking data, and communicating the eye tracking data to control circuitry (see FIG. 3) for processing. The control circuitry may then determine when a vehicle component is to be controlled in response to the settled gaze of the vehicle occupant in conjunction with contemporaneous gaze context. In some embodiments, one or more of the image sensors 150, 152, 154 may also be used as a context sensor to monitor the vehicle cabin and aid in determining gaze context. Both the settled gaze of the vehicle occupant 104 and the gaze context are discussed in greater detail below. In some embodiments, the eye tracking may be performed using a commercial eye tracking system, such as the EyeX eye tracking system from Tobii of Stockholm, Sweden. In some embodiments, the eye tracking may be performed by adapting webcam-based eye tracking tools, such as PACE from Ennable (http://www.ennable.com), Turkergaze project through Princeton University (available on Github at https://github.com/Princeton Vision/TurkerGaze), and WebGazer project through Brown University (available on Github at https://github.com/brownhci/WebGazer). Other muti-camera eye tracking systems, such as systems from Smart Eye of Gothenburg, Sweden may also be used for eye tracking. Any of these systems may be used to track eye movements of, and therefore monitor the gaze of, the vehicle occupant 104.

The control circuitry may be communicably coupled to some or all of the active vehicle components and combination vehicle components for purposes of controlling those vehicle components. The control system may also be communicably coupled to other vehicle systems, including the audio system, the navigation system, the climate control system, and the cruise control system, among others. The control circuitry may control one or more vehicle components in response to eye tracking data received from one or more of the image sensors 150, 152, 154 and a contemporaneous gaze context. In an example scenario, the vehicle occupant 104 may be driving the vehicle 102 and to a destination and navigating to that destination using a map 144 with turn-by-turn instructions displayed on the infotainment center display 134. In this scenario, the gaze-monitoring system may have the capability of determining when a vehicle occupant is squinting (partially closed eyes to see more clearly), such that the gaze-monitoring system itself may also be used as a gaze context sensor. While driving, the vehicle occupant 104 may look at the map displayed on the infotainment center display 134 and may be squinting while looking. One or more of the image sensors 150, 152, 154 capture the look and the squinting at the map and communicate data concerning the look and the squinting to the control circuitry. The control circuitry may interpret the look as a settled gaze toward a vehicle component (the infotainment center display 134), and the control circuitry may interpret the squinting as gaze context. In response to the settled gaze and gaze context, the control circuitry may generate and send a control signal to the infotainment center display 134 to perform a zoom in function on the displayed map, with the focus of the zoom being the current position of the vehicle 102 on the map. As an alternative, or in addition, the control signal may generate and send a control signal to the infotainment center display 134 to increase the brightness of the infotainment center display 134. In some embodiments, one or both aforementioned control signal responses by the control circuitry may be predetermined by prior programming. In some embodiments, one or both aforementioned control signal responses may be determined by real-time artificial intelligence analysis performed by the control circuitry.

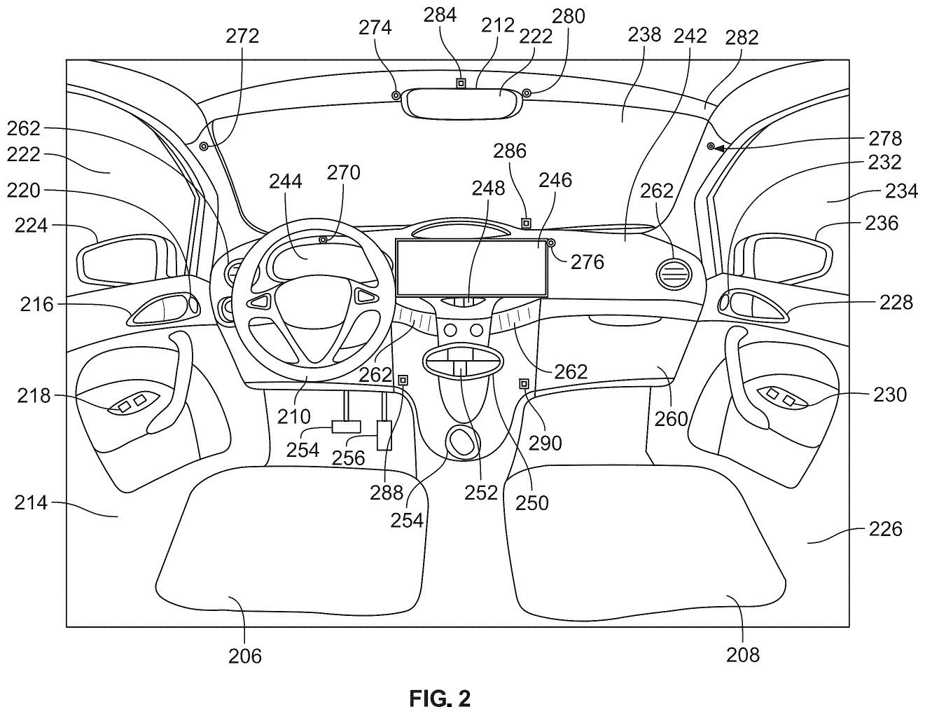

FIG. 2 illustrates the interior of another vehicle 202 which includes a gaze-monitoring system for contextually controlling vehicle components based on a vehicle occupant's gaze. For purposes of clarity, the vehicle 202 is shown without any vehicle occupants, such that both the driver seat 206 and the passenger seat 208 are empty. The vehicle 202 includes several vehicle components, many of which are common to existing vehicles. Some of the vehicle components are passive vehicle components, and some vehicle components are active vehicle components, and still other vehicle components may be combination vehicle components having both passive vehicle component qualities and active vehicle component qualities. Some of the vehicle components shown include: a steering wheel 210, a rear view mirror mount 212, a rear-view mirror 222, a driver door 214, a driver door handle 216, driver window switches 218, a driver door lock switch 220, a driver door window 222, a driver side mirror 224, a passenger door 226, a passenger door handle 228, a passenger window switch 230, a passenger door lock switch 232, a passenger door window 234, a passenger side mirror 236, a windshield 238, a dashboard 242, a driver display 244 for displaying certain vehicle status information including road speed, an infotainment center display 246 for providing vehicle occupants with interactive control over vehicle systems, programable buttons 248 for interacting with the infotainment center display 246, cabin climate controls 250, a hazard lights control 252, a vehicle power control 254, an accelerator pedal 256, a brake pedal 258, a glove box door 260, and air vents 262.

The vehicle 202 may also include other vehicle components that are accessible and/or viewable from within the vehicle cabin, including, but not limited to: a heads-up driver display, cabin lights, windshield wipers, windshield wiper controls, driving light controls, parking light controls, turn signal controls, cruise control controls, side view mirror controls, driver seat position controls, passenger seat position controls, sunroof controls, convertible top controls, and device charging & interface ports, among others. As indicated previously, in some embodiments, every part of the vehicle 202 may be considered a vehicle component for purposes of monitoring the gaze of the vehicle occupant. Similarly, in some embodiments the scope of what is and is not a vehicle component, for purposes of monitoring a vehicle occupant's gaze, may be pre-defined. Likewise, in some embodiments the scope of what is and is not a vehicle component, for purposes of monitoring a vehicle occupant's gaze, may start as being pre-defined and thereafter be enlarged based on the usage, habits, and/or preferences of the vehicle occupant (which may, in many instances, be the vehicle owner or regular operator).

The vehicle 202 also includes several image sensors 270-280 integrated as part of the gaze-monitoring system. The image sensors 270-280 are located within the cabin for monitoring the gaze of one or more vehicle occupants. Some embodiments may include more or fewer image sensors than shown in FIG. 2. Each of the image sensors 270-280 may operate in the visible light spectrum. In some embodiments, one or more of the image sensors 270-280 may operate in the infrared light spectrum. In some embodiments, one or more of the image sensors 270-280 may operate across multiple light spectrums. The image sensor 270 is located adjacent the driver display 244 to provide a face-forward view of the vehicle occupant in the driver seat 206 while the vehicle 202 is being driven. Similarly, the image sensor 276 is located adjacent the infotainment center display 246 to provide a face-forward view of the vehicle occupant in the passenger seat 208. The other image sensors 272, 274, 278, 280 are positioned along the upper windshield frame 282. The image sensors 272, 274 are positioned to provide additional views of the eyes of the vehicle occupant in the driver seat 206 and may aid in monitoring the gaze of the vehicle occupant in the driver seat 206 when that vehicle occupant tilts and/or turns their head to look in directions other than straight ahead. The image sensors 278, 280 are positioned to provide additional views of the eyes of the vehicle occupant in the passenger seat 208 and may aid in monitoring the gaze of the vehicle occupant in the passenger seat 208 when that vehicle occupant tilts and/or turns their head to look in directions other than straight ahead.

One or more of the image sensors 270-274 may monitor the gaze of the vehicle occupant in the driver seat 206 by tracking eye movements of that vehicle occupant, generating eye tracking data, and communicating the eye tracking data to control circuitry (see FIG. 3) for processing. Similarly, one or more of the image sensors 276-280 may monitor the gaze of the vehicle occupant in the passenger seat 208 by tracking eye movements of that vehicle occupant, generating eye tracking data, and communicating the eye tracking data to the control circuitry for processing. The control circuitry may then determine when a vehicle component is to be controlled in response to the settled gaze of one of the vehicle occupants in conjunction with the gaze context. The back seat of the vehicle 202 may include additional image sensors to monitor the gaze of back seat passengers.

In some embodiments, each of the image sensors 270-280 may also be used as a context sensor to monitor the vehicle cabin and aid in determining gaze context. Other types of context sensors may also be incorporated into the vehicle 202 and communicably coupled to the control circuitry. In some embodiments, context sensors may be positioned inside and/or outside the cabin of the vehicle 202. In addition to the image sensors 270-280, the vehicle 202 as shown includes the following context sensors: a microphone 284, a windshield sensor 286, a driver zone temperature sensor 288, a passenger zone temperature sensor 290. The microphone 284 may be used to detect sound within the cabin of the vehicle 204. The detected sound may be spoken words by one of the vehicle occupants, ambient noises from inside the cabin of the vehicle 202, and/or ambient noises that originate from outside the cabin of the vehicle. The detection of sound may be communicated to the control circuitry, and in response the control circuitry may determine whether the detected sound is a contemporaneous gaze context. The windshield sensor 286 may be used to detect rain on the outside surface of the windshield 238 and to detect condensation on the inside surface of the windshield 238. The detection of rain and/or condensation may be communicated to the control circuitry, and in response, the control circuitry may determine whether the detected rain and/or condensation is a contemporaneous gaze context. The driver zone temperature sensor 288 may be used to detect an ambient temperature in the vicinity of the driver of the vehicle 204, and the passenger zone temperature sensor 290 may be used to detect an ambient temperature in the vicinity of the front seat passenger of the vehicle 204. Both the driver zone temperature sensor 288 and the passenger zone temperature sensor 290 may regularly detect the ambient temperatures in the respective zones and communicate the detected temperatures to the control circuitry. In response, the control circuitry may determine whether a detected ambient temperature serves as a contemporaneous gaze context for any vehicle occupant gazes. The control circuitry may process data from other context sensors in a similar manner.

In some embodiments, each active vehicle component and each combination vehicle component may communicate data to the control circuitry reporting the status of the respective vehicle component. With data collected from each active vehicle component and each combination vehicle component, the control circuitry may interpret the data from each of these vehicle components to represent gaze context. In an example scenario, a vehicle occupant may be seated in the passenger seat 208 while the vehicle 202 is being driven by another occupant.

The passenger may not be familiar with the vehicle 202, and decides they are cold. This prompts the passenger to look at the nearest air vent 262, and that look by the passenger may be identified as a settled gaze by the control circuitry using the image sensor 276. At the same time, the control circuitry may receive contemporaneous temperature data from the passenger zone temperature sensor 290 indicating that the ambient temperature near the passenger is low, at about 68° F. (20° C.) in this scenario. The control circuitry may also receive contemporaneous data from the climate control system indicating that the passenger zone set point temperature is 65° F. (18.3° C.) and the air conditioning blower is blowing air at a medium high rate. The control circuitry may determine that both the ambient temperature near the passenger and the status of the climate control system, as it relates to the passenger zone, are gaze context for the identified settled gaze of the passenger. In response to the passenger's gaze and the gaze context, the control circuitry identifies the climate control system for controlling and communicates a control signal to the climate control system to increase the set point temperature of the passenger zone to 67° F. (19.4° C.) and to reduce the blower rate to a medium low rate.

In another example scenario, a vehicle occupant may be seated in the passenger seat 208 while the vehicle 202 is being driven by another occupant. The passenger may not be familiar with the vehicle 202, including how to use the infotainment center display 246. The passenger may decide they would like some music playing for the drive. The passenger asks the driver, “would you mind if I play some music?” while looking at the infotainment center display 246, which is displaying vehicle status information in the moment the passenger looks at the infotainment center display 246. The driver may respond to the passenger, “Go ahead, play some fun music.” The passenger looking at the infotainment center display 246 may be identified as a settled gaze by the control circuitry using the image sensor 276. The passenger's question and/or the driver's response may be detected by the microphone 284, and the control circuitry may interpret the question and/or the answer as relating to music and a desire to play music. The passenger's question and/or the driver's response may therefore be identified by the control circuitry as contemporaneous gaze context. Such situations might be, for example, detecting a driver saying, “Go ahead, play some fun music,” or the driver giving a thumbs-up gesture as a response to the passenger. In response to the passenger's settled gaze and the gaze context, the control circuitry identifies the infotainment center display 246 as the vehicle component to be controlled, and based on the gaze context, the control circuitry may generate a control signal to the infotainment center display 246 to display the music interface. The passenger is thus relieved from trying to figure out how to navigate the GUI menus on the infotainment center display 246 to find the music interface.

The context sensors may be any sensor associated with the vehicle 202 that detects a condition in or near the vehicle. Several examples of context sensors follow. A temperature sensor may detect the ambient temperature external to the vehicle 202, such that the external temperature may be a gaze context. A microphone, whether positioned inside or outside the vehicle cabin, may detect sounds external to the vehicle cabin (e.g., sirens, loud crashes, etc.), such that sounds external to the vehicle cabin may be a gaze context. The vehicle may be equipped with one or more cameras, whether positioned inside or outside the vehicle cabin, such that the presence, location, and/or status of other visible things (e.g., other vehicles, cyclists, pedestrians, the road, road signs, etc.) on and nearby the road may be a gaze context. The vehicle may be equipped with a LIDAR system and/or RADAR system, such that the presence, location, and/or status of other things visible in the spectrum in which these systems operate (e.g., other vehicles, cyclists, pedestrians, the road, road signs, etc.) on and nearby the road may be a gaze context. As already indicated, any vehicle systems and/or components may also serve as context sensors to provide gaze context, including but not limited to a rain sensor, a condensation sensor, a speedometer, an acceleration sensor, a braking sensor, an engine/motor status sensor, a fuel sensor, a battery charge sensor, a climate control system, a sound system, a voice control system, any system status displayed on or able to be displayed on the driver display 244, and any system status displayed on or able to be displayed on the infotainment center display 246, among other systems included with the vehicle 204. Certain vehicle systems may act as self-sensors in that the sensed data communicated to the control circuitry is the status of the particular vehicle system itself. For example, the navigation system may communicate data to the control circuitry relating to the selected destination of the vehicle occupants, the status of the navigation system being displayed on the infotainment center display 246, and the like. As another example, the climate control system may communicate data to the control circuitry relating to the set point temperature for different zones in the vehicle cabin (e.g., driver zone, passenger zone, rear seat zone), operating speeds for the blowers, whether the air is on fresh or recirculate, and the like.

A gaze-monitoring system 300 for controlling vehicle components in response to a vehicle occupant's gaze and a contemporaneous gaze context is shown in the block diagram of FIG. 3. The gaze-monitoring system 300 includes control circuitry 302, a storage 304, and input/output (I/O) circuitry 306. The I/O circuitry 306 communicably couples the control circuitry 302 with other electronic systems associated with the vehicle, including the driver image sensor(s) 308, the front passenger image sensor(s) 310, and the rear passenger image sensor(s) 312. The gaze-monitoring system 300 includes at least one driver image sensor 308 for the driver, at least one front passenger image sensor 310 for a passenger in the front passenger seat, and at least one rear passenger image sensor 312 for rear seat passengers. In some embodiments, the number of rear passenger seats, and thus the number of rear passenger image sensors 312, may be determined by the number of rear passenger seat belts. The number of image sensors 308, 310, 312 may vary for each seat location within the vehicle. For example, the gaze-monitoring system 300 may include three image sensors for each of the driver image sensor(s) 308 and the front passenger image sensor(s) 310, and the gaze-monitoring system 300 may include a single image sensor for each rear passenger seat. In some embodiments, the gaze-monitoring system 300 may include a single image sensor for each seat location in the vehicle. In some embodiments, the gaze-monitoring system 300 may include multiple image sensors for each seat location in the vehicle.

The I/O circuitry 306 communicably couples the control circuitry 302 to the infotainment center display 246, the I/O circuitry 306, the wireless network 316, the context sensors 330, and the vehicle components 370. In some embodiments, the control circuitry 302 and the I/O circuitry 306 may be part of a unified integrated circuit. The control circuitry 302 communicates with the infotainment center display 246 for purposes of displaying a GUI associated with the gaze-monitoring system 300. The control circuitry 302 may communicate with other systems, such as the server 318, via the wireless network 316. In some embodiments, processes described herein may be performed by one or both the control circuitry 302 and the server 318. The control circuitry 302 communicates with the context sensors 330 to collect data that may be evaluated and used as gaze context. The control circuitry 302 may communicate control signals to the vehicle components 370 as needed in response to the settled gaze and contemporaneous gaze context of a vehicle occupant.

The control circuitry 302 may be based on any suitable control circuitry and includes control circuits and memory circuits, which may be disposed on a single integrated circuit or may be discrete components. In some embodiments, the control circuitry 302 may be integrated with control circuitry used to control and monitor other vehicle functions, such as vehicle driving systems, vehicle power systems, the applications and GUI displayed on the driver display (e.g., speedometer, engine/motor status, fuel/energy status, etc.), the applications and GUI displayed on the infotainment center display (e.g., audio entertainment system, navigation system, climate control system, communication system, personal device interface, etc.), and the climate controls, among others. As referred to herein, “control circuitry” should be understood to mean circuitry based on at least one of microprocessors, microcontrollers, digital signal processors, programmable logic devices, field-programmable gate arrays (FPGAs), or application-specific integrated circuits (ASICs), etc., and may include a multi-core processor (e.g., dual-core, quad-core, hexa-core, or any suitable number of cores). In some embodiments, the control circuitry 302 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, the control circuitry 302 may be implemented in hardware, firmware, or software, or a combination thereof.

The storage 304 may be any device for storing electronic data, such as random-access memory, solid state devices, quantum storage devices, hard disk drives, non-volatile memory or any other suitable fixed or removable storage devices, and/or any combination of the same. The storage 304 may be an electronic storage device that is integrate with the control circuitry 302. As referred to herein, the terms “storage” and “storage device” may be used interchangeably, and these terms should be understood to mean any device for storing electronic data, computer software, or firmware, such as random-access memory, read-only memory, hard drives, solid state devices, quantum storage devices, or any other fixed or removable storage devices, and/or any combination of the same that are suitable for use within the environment of a vehicle. The storage 304 may store data relating to the monitored gazes of vehicle occupants, data that may represent gaze context, data relating to vehicle occupants and habits and/or preferences of vehicle occupants, and historical data relating to vehicle occupants, gazes, and gaze contexts, among other types of data. Nonvolatile memory may also be used (e.g., to launch a boot-up routine and other instructions). In some embodiments, cloud-based electronic storage may be used to supplement the storage 304.

The control circuitry 306 may be configured to send and receive control signals, requests, and other data via the I/O circuitry 312. The I/O circuitry 312 may communicatively couple the control circuitry 306 to one or more communication paths, shown as arrows in FIG. 3. Multiple I/O functions may be provided by one or more of these communication paths but may be shown as a single path to avoid overcomplicating the drawing. The I/O circuitry 306 may include any type of communications circuitry that enables the control circuitry 302 to communicate, either directly or indirectly, with other vehicle components, context sensors, devices, servers, networks, and the like. Direct communications circuitry may include those that use protocols such as USB, Bluetooth, serial, and the like. Indirect communications circuitry may include those that use a network (e.g., a local area network (LAN) such as WiFi, a wide area network (WAN) such as the Internet, and the like) interposed between devices. The I/O circuitry 306 enables the control circuitry 302 to receive data communicated from the image sensor(s) 308, 310, 312 and the context sensors 330 and to communicate control signals to the vehicle components 370. The I/O circuitry 302 also enables the control circuitry 302 to communicate with the infotainment center display 246. In some embodiments, the control circuitry 302 may be configured to display a GUI on the infotainment center display 246 so that a vehicle occupant can interact with user options and preferences offered by the gaze-monitoring system 300. In some embodiments, the I/O circuitry 302 may be configured to provide a wired connection to devices outside of the context sensors 330 and the vehicle components 370. As such, the I/O circuitry 302 may include a physical port such as an audio jack, USB port, ethernet port, or any other suitable connection for receiving input over a wired connection. In some embodiments, the I/O circuitry 302 may be configured to provide a wireless connection, such as Bluetooth, Wi-Fi, WiMAX, GSM, UTMS, CDMA, TDMA, 3G, 4G, 4G LTE, 5G, or any other suitable wireless transmission protocol. As such, the I/O circuitry 302 may include a wireless transceiver configured to send and receive data via Bluetooth, Wi-Fi, WiMAX, GSM, UTMS, CDMA, TDMA, 3G, 4G, 4G LTE, 5G, or other wireless transmission protocols. In some embodiments, the I/O circuitry may include multiple modules, with each module configured for communications using different circuitry and protocol.

The control circuity 302 may communicate with the server 318 wirelessly via the wireless network 316, and this wireless communication may utilize one or more of the aforementioned wireless transmission protocols or any other wireless transmission protocol. The wireless network 316 may include one or more networks including the Internet, a mobile phone network, a mobile voice or data network (e.g., a 5G, 4G, or LTE network), cable network, public switched telephone network, or other types of communication network or combinations of communication networks.

The server 318 includes control circuitry 320, storage 322, and I/O circuitry 324. The control circuitry 320 may be based on any suitable control circuitry and includes control circuits and memory circuits, which may be disposed on a single integrated circuit or may be discrete components. In some embodiments, the control circuitry 320 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, the control circuitry 320 may be implemented in hardware, firmware, or software, or a combination thereof.

The storage 322 may be any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 8D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. The storage 322 may be an electronic storage device that is integrate with the control circuitry 320. The storage 322 may be used to store several types of content, metadata, and/or other types of data. Non-volatile memory may also be used (e.g., to launch a boot-up routine and other instructions). Cloud-based electronic storage may be used to supplement the storage 322.

The I/O circuitry 324 may include any type of communications circuitry that enables the control circuitry 320 to communicate, either directly or indirectly, with other devices, servers, networks, and the like, including the control circuitry 302. Direct communications circuitry may include those that use protocols such as USB, Bluetooth, serial, and the like. Indirect communications circuitry may include those that use a network (e.g., a local area network (LAN) such as WiFi, a wide area network (WAN) such as the Internet, and the like) interposed between devices. In some embodiments, the I/O circuitry 324 may be configured for communications using multiple different circuitry and protocols (e.g., Bluetooth, WiFi, 5G, 4G, LTE, Ethernet, USB, etc.). In some embodiments, the I/O circuitry 324 may include multiple modules, with each module configured for communications using different circuitry and protocol.

The infotainment center display 314 may be any type of display screen that is suitable for serving as the center console display in a vehicle. In some embodiments, the infotainment center display 246 is a touch-sensitive display that is capable of interfacing with control circuitry in the vehicle to provide touch-sensitive GUI access to different systems incorporated into the vehicle (e.g., audio entertainment system, navigation system, climate control system, communication system, personal device interface, etc.). In some embodiments, the infotainment center display 246 may be an LED screen, an OLED screen, and the like.

The image sensors 308, 310, 312 may be digital optical cameras configured to generate images of the vehicle occupants, including at least the eyes of vehicle occupants. In some embodiments, the image sensors 308, 310, 312 may include a charge-coupled device (CCD) and/or a complementary metal-oxide semiconductor (CMOS) type image sensor. In embodiments with multiple image sensors 308, 310, 312 for each vehicle occupant, the image sensors 308, 310, 312 may be positioned to view each respective occupant from different angles, as doing so may enhance the eye tracking capabilities of the system 300. In some embodiments, the image sensors 308, 310, 312 may include the capability of capturing video.

Some of the context sensors 330 may be dedicated context sensors, while some of the context sensors may serve multiple purposes within the vehicle. Other context sensors may be in communication with the control circuitry 302 and not be fixed to the vehicle, such as user devices (e.g., smartphones, tablet computers, smart watches, hearing aids, and other wearable devices etc.) that wirelessly communicate with systems included with the vehicle. The use of a particular context sensor is not intended to be limited to a dedicated use as a context sensor in the event that no other purpose for that context sensor is indicated herein. Likewise, the use of a particular context sensor is not intended to be limited to multi-purpose uses where multiple purpose uses are identified herein; such multi-purpose use context sensors may be converted to or used as dedicated context sensors in some embodiments. The list of context sensors 330 shown in FIG. 3 is intended to be non-exhaustive and non-limiting. The control circuitry 302 may receive context data from one or more of the following context sensors 330 via the I/O circuitry 306 (a non-limiting example context data that may be produced by a particular context sensor is shown in parentheses where indicated): speedometer 332 (speed of the vehicle), accelerometer 334 (vehicle acceleration), fuel/energy levels 336, window controls 338 (status of respective windows), sunroof controls 340 (status of sunroof), climate system 342 (status of climate system), infotainment system 344 (status of what is displayed on the infotainment center display and the status of the GUI elements displayed), windshield sensor 346 (data relating to rain and window condensation), rear window sensor 348 (data relating to window condensation), cabin microphone 350 (sound/speech data), occupant image sensors 352 (data relating to vehicle occupants, facial expressions, and in some embodiments identity), driving cameras 354 (data relating to the road and surroundings), RADAR/LIDAR 356 (data relating to the road and surroundings), external temperature sensor 358 (outside temperature), and cabin temperature sensors 360 (cabin temperatures-may be limited to specific zones within the cabin). In some embodiments, the control circuitry 302 may receive a regular stream of data from one or more of the context sensors 330. In some embodiments, the control circuitry 302 may poll one or more of the context sensors 330 in response to the vehicle occupant's settled gaze on a vehicle component or a gaze in a particular direction. In some embodiments, one or more of the context sensors 330 may cache data for a predetermined period and transmit the cached data to the control circuitry 302 when polled. In such embodiments, the cached data may aid in providing the control circuitry 302 with a gaze context just prior to the time of the vehicle occupant's settled gaze. By determining the gaze context just prior to the settled gaze, the control circuitry 302 may be better able to predict the vehicle occupant's intent at the time of the settled gaze.

In some embodiments, the control circuitry 302 may determine that a vehicle occupant's settled gaze may be actionable when the settled gaze is directed toward a vehicle component or in a particular direction for a period that exceeds a predetermined threshold. In such embodiments, the predetermined threshold may be set with a range of as low as hundredths of a second. In some embodiments, the predetermined threshold may be set with a range of tenths of a second or one or more seconds. In some embodiments, the predetermined threshold may be based on the vehicle component, or the direction. at which the occupant's gaze is directed. For example, while a driver is driving a vehicle, the driver's gaze may drift to the rear-view mirror for approximately a tenth of a second or less before returning to the road ahead, and in comparison the driver's gaze may linger for half a second or longer on the driver display or on the infotainment center display before returning to the road ahead. In the former instance, the driver's gaze may be considered a settled gaze on the rear-view mirror after the tenth of a second, while the driver's gaze may need to linger on the infotainment center display for more than a half second before the gaze is determined to be a settled gaze. Thus, each vehicle component may be assigned a different threshold to determine when a gaze toward that vehicle component, in combination with a gaze context, is a settled gaze. In still other embodiments, a vehicle occupant's gaze may be determined to be a settled gaze if the gaze is directed at a particular vehicle component and the gaze context meets predetermined criteria. For example, if a driver and passenger are both in the vehicle, the music is somewhat loud, and the driver and passenger have started to talk, a very brief look at the infotainment center display (less than a half second) combined with sound data from the microphone which indicates the vehicle occupants are trying to speak to each other, the control circuitry may determine that the brief look at the infotainment center display is a settled gaze based on the context data and the length of the gaze. In such an embodiment, for example, the control circuitry may generate a signal to the infotainment center display to decrease the volume of the music.

FIG. 3 also includes a non-limiting list of vehicle components 370 that may be controlled based on the gaze of a vehicle occupant and a contemporaneous gaze context. In some embodiments, control of one of the vehicle components 370 may be accomplished by a vehicle occupant gazing at a particular vehicle component. In some embodiments, control of one of the vehicle components 370 may be accomplished by a vehicle occupant gazing at a vehicle component that is associated with another vehicle component to be controlled. For example, a settled gaze at one of the cabin air vents (which may be passive vehicle components that cannot be controlled by the control circuitry 302), with an appropriate gaze context, may cause the climate control system to be controlled by the control circuitry 302. As another example, a settled gaze at the hazard lights button on the dashboard, with an appropriate gaze context, may cause the external hazard lights to be activated by the control circuitry 302. Each of the vehicle components 370 are either active vehicle components or combination vehicle components, as those are the types of vehicle components that may perform a function in response to receiving a control signal from the control circuitry 302. The list of vehicle components 370 shown in FIG. 3 is intended to be non-exhaustive and non-limiting. The control circuitry 302 may communicate control signals to one or more of the following vehicle components 370 via the I/O circuitry 306 (a non-limiting example of the functionality of a respective vehicle component 370 that may be controlled is shown in parentheses): climate control system 372 (adjust heating, cooling), infotainment system 374 (adjust a UI control displayed on the display screen; display the UI for a different vehicle system on the display screen), turn signals 376 (activate/deactivate the turn signals), cruise control 378 (adjust cruise control settings), windshield wipers 380 (adjust wiper mode settings; turn wipers on/off), rearview mirror 382 (activate mirror dimming), rear window defogger 384 (activate the defogger), door locks 386 (lock/unlock the doors; set/unset the child locks), windows controls 388 (roll up/down windows), sunroof controls 390 (open/close/tilt/un-tilt the sunroof), adjustable seats 392 (adjust seat position), and seat heaters 394 (activate/deactivate seat heaters), interior lights 396 (turn on/off lights).

In some embodiments, the control circuitry 302 executes instructions for an application stored in the storage 304. Specifically, the control circuitry 302 may be instructed by the application to perform one or more of the functions discussed herein. In some embodiments, any action performed by the control circuitry 302 may be based on instructions received from the application. For example, the application may be implemented as software or a set of and/or one or more executable instructions that may be stored in the storage 304 and executed by the control circuitry 302. The application may be configured to be executed solely on the control circuitry 302. In some embodiments, the application may be a client/server application where only a client application is executed on the control circuitry 302, and a server application resides the server 318, such that the client application and the server application are executed cooperatively or in a distributed manner to perform the functions discussed herein.

The application may be implemented using any suitable architecture. For example, it may be a stand-alone application wholly implemented on the control circuitry 302. In such an approach, instructions for the application are stored locally (e.g., in the storage 304), and data for use by the application is received from one or more of the image sensors 308, 310, 312, the context sensors 330, or the server 318. In some embodiments, data from the server may be downloaded on a periodic basis when the vehicle is within range of a suitable wireless network for communicating with the server 318. The control circuitry 302 may retrieve instructions for the application from the storage 304 and process the instructions to perform the functionality described herein. Based on the processed instructions, the control circuitry 302 may determine an action to perform in response to input received via the I/O circuitry 1018. As indicated elsewhere herein, the input may include eye tracking data and contemporaneous context data. In some embodiments, the contemporaneous context data may be retrieved from the storage 304 (e.g., vehicle occupant habit data, vehicle occupant preference data, and other information specific to a vehicle occupant that may have previously been saved to the storage 304).

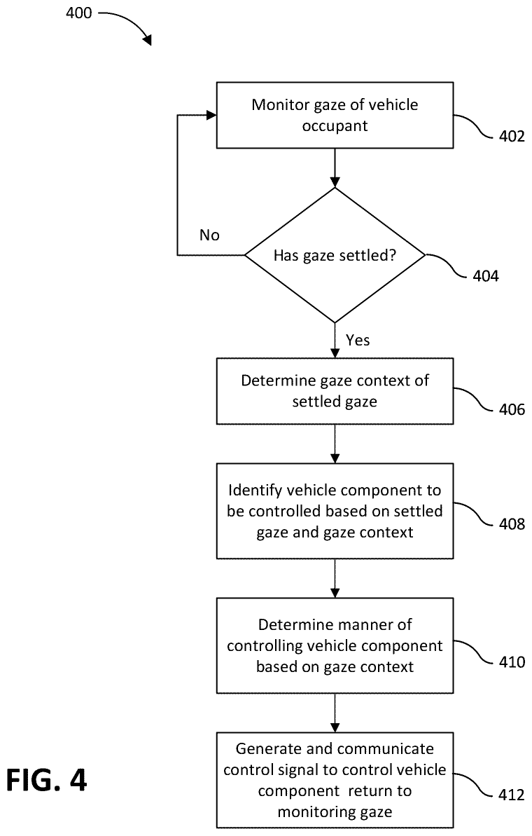

FIG. 4 shows a flowchart illustrating the steps of a process 400 for a gaze-monitoring system to control a vehicle component based on an occupant's gaze and a gaze context. The process 400 may be implemented on the systems discussed herein and similar systems for monitoring a vehicle occupant's gaze and controlling a vehicle component based on the gaze and a gaze context. One or more actions of the process may be incorporated into or combined with one or more actions of any other process or embodiment described herein. At step 402, the gaze-monitoring system monitors the gaze of a vehicle occupant, and at step 404 the gaze-monitoring system determines whether the gaze of the vehicle occupant has settled. If the gaze has not settled, then monitoring the gaze at step 402 continues. As indicated elsewhere herein, whether a gaze has settled may be based on the time length of the gaze at a vehicle component, the context of the gaze, the duration of a gaze at a particular vehicle component or in a particular direction, and/or the number of repeated gazes at a particular vehicle component or in a particular direction. For example, a gaze may be considered settled when the driver looks at cruise control buttons on the steering wheel for more than two tenths of a second. As another example, a gaze may be considered settled when the vehicle occupant looks briefly at the infotainment center display at the start of a new song playing. As another example, a gaze may be considered settled when the driver looks at the driver side mirror for longer than a predetermined period. As yet another example, a gaze may be considered settled when the driver looks out the driver window, and not at the side view mirror, for over a second.

When the gaze is determined to be settled, at step 406, the gaze-monitoring system determines the gaze context of the settled gaze. The gaze context is determined from data collected from various context sensors and/or from data received from vehicle systems (e.g., the infotainment system, the climate control system, and the like). In the example of the gaze settling on the cruise control buttons, the gaze context may be determined to be (based on data from associated sensors) that there are no other vehicles in front of the vehicle and the vehicle is going slower than the speed limit. In the example of the gaze settling on the infotainment center display, the gaze context may be the loudness of the now-playing song as compared to the previously played song. In the example of the gaze settling on the driver side mirror, the gaze context may be an immediately prior gaze (even if not a settled gaze) by the driver at the rear-view mirror in combination with a determination that the rear window has condensation. In the example of the gaze settling out the driver window, the gaze context may be potentially hazardous or unsafe conditions (e.g., due to other cars, people, or objects) detected nearby on the road from one or more of external cameras, RADAR, and/or LIDAR, along with the passenger also gazing out the driver window in the same direction.

As is seen by the example of the gaze settling on the driver side mirror, a prior gaze of a vehicle occupant may serve as gaze context for a subsequent settled gaze of the vehicle occupant. In some embodiments, a gaze context may serve to reduce the predetermined period used by the gaze-monitoring system to determine when a gaze is a settled gaze. For example, where a settled gaze at the driver side mirror by the driver is predetermined to have a period of a half second, a settled gaze that is part of a sequence of gazes might be predetermined to have a period of a quarter second. Thus, if the driver makes multiple sequential gazes at the driver side mirror, the predetermined period for determining a settled gaze may be reduced to a quarter second by identifying the sequence of gazes. In some embodiments, a gaze sequence may be defined by two or more gazes at the same vehicle component or in the same direction, with less than a predetermined period (e.g., 1 second, 2 seconds, 5 seconds, etc.) between gazes. In some embodiments, the prior gazes in a gaze sequence need not be settled to serve as gaze context. Whether or not a prior gaze should be a settled gaze before serving as gaze context for the subsequent gaze may depend on one or more other contemporaneous gaze contexts. In the example, the rear-window having condensation is also a gaze context, which means that a very short prior gaze (not a settled gaze) on the rear-view mirror followed by a settled gaze on the driver side mirror may indicate that the intent of the driver is to use the mirrors to see behind the car. Thus, in this example the overall context indicates that the prior gaze need not be a settled gaze. In other scenarios, a settled prior gaze may be sufficient gaze context for the subsequent settled gaze. For example, in a scenario where a driver turns around for a settled gaze through the rear window after having made a prior settled gaze at the rear-view mirror, the gaze-monitoring system may determine that the two settled gazes indicate an intent by the driver to see better toward the back of the vehicle. In response to the two sequential settled gazes, the gaze-monitoring system may determine that the rear-view camera should be activated and displayed on the infotainment center display. In still other scenarios, it may be desirable to have additional contemporaneous gaze context to a prior settled gaze to determine that an action should be taken in response to a subsequent settled gaze.

In step 408, the gaze-monitoring system identifies a vehicle component to be controlled based on the settled gaze and the gaze context. In the example of the gaze settling on the cruise control buttons, the vehicle component to be controlled is the cruise control system. In the example of the gaze settling on the infotainment center display, the vehicle component to be controlled is the infotainment system, and particularly the audio subsystem of the infotainment system. In the example of the gaze settling on the driver side mirror, the vehicle component to be controlled is the rear-window defogger. In the example of the gaze settling out the driver window, the vehicle component to be controlled may be the hazard lights and/or the infotainment center display.

In step 410, the gaze-monitoring system determines the manner of controlling the identified vehicle component(s) based on the gaze context. In the example of the gaze settling on the cruise control buttons, the gaze-monitoring system may determine that the appropriate control is to increase the set speed of the cruise control system to the speed limit. In the example of the gaze settling on the infotainment center display, the gaze-monitoring system may determine that the appropriate control is to lower the volume of the music. In the example of the gaze settling on the driver side mirror, the gaze-monitoring system may determine that the appropriate control is to activate the rear-window defogger. In the example of the passenger gaze settling out the driver window, the gaze-monitoring system may determine that the appropriate control is to activate the hazard lights and/or display a road hazard warning symbol on the infotainment center display.

In step 412, the gaze-monitoring system generates and communicates a control signal to control the vehicle component(s) identified in step 408 in the manner determined in step 410. The form and composition of the control signal is based on the vehicle component being controlled. In the example of the gaze settling on the cruise control buttons, the control signal to the cruise control system may be a command signal to adjust the set speed followed by a data signal indicating the new set speed. In the example of the gaze settling on the infotainment center display, the control signal to the infotainment system may be a command signal to indicate a function to perform (e.g., volume control) and any parameters associated with the function (e.g., a parameter to set the volume level lower). In the example of the gaze settling on the driver side mirror, the control signal to the rear-window defogger may be an increased voltage on a control wire for the defogger to activate the defogger. In the example of the passenger gaze settling out the driver window, the control signal to the hazard lights may be an increased voltage on control wire for the hazard lights controller, and the control signal to the infotainment center display may be a data stream to cause the infotainment center display to display a flashing warning symbol.

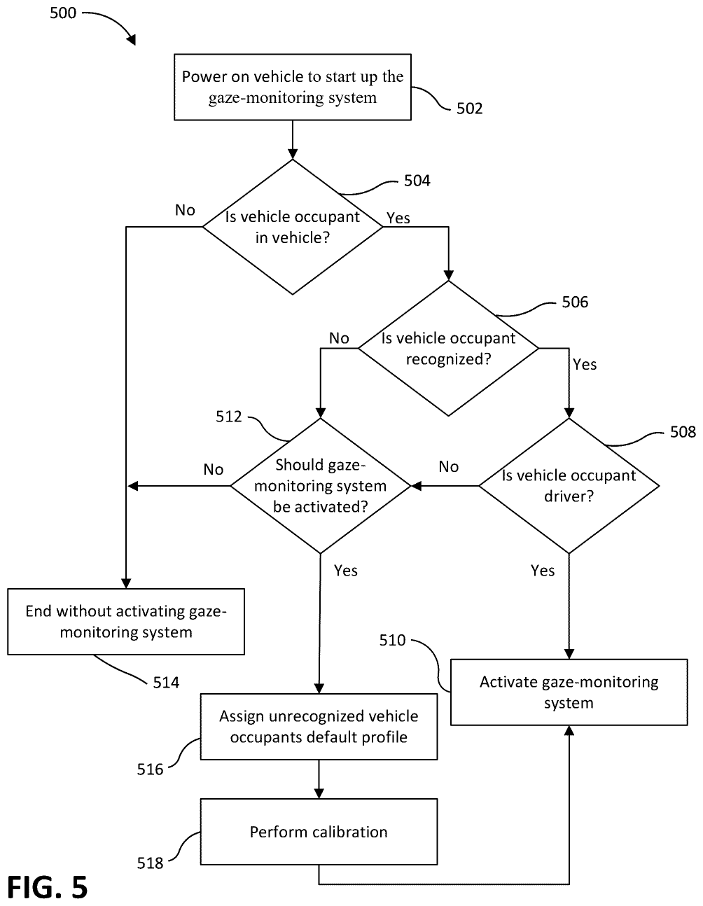

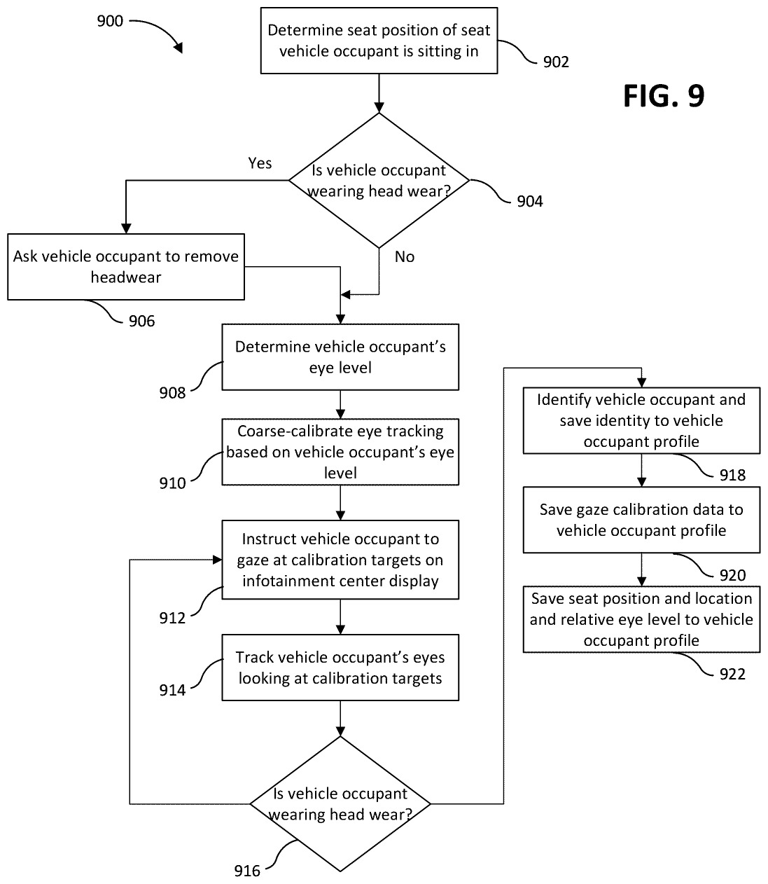

FIG. 5 shows a flowchart illustrating the steps of a process 500 for vehicle occupant recognition as part of a gaze-monitoring system when a single vehicle occupant is in the vehicle. The process 500 may be implemented on the systems discussed herein and similar systems for monitoring a vehicle occupant's gaze and controlling a vehicle component based on the gaze and a gaze context. One or more actions of the process may be incorporated into or combined with one or more actions of any other process or embodiment described herein. At step 502, the vehicle is powered on to start up the gaze-monitoring system, and at step 504, the gaze-monitoring system determines if an occupant is in the vehicle using the optical sensors. If there is no occupant in the vehicle, the process 500 ends without activating the gaze-monitoring system at step 514. If there is an occupant in the vehicle, at step 506, the gaze-monitoring system determines if the occupant is recognized, and at step 508, the gaze-monitoring system determines if the occupant is the driver using the optical sensors. If the occupant is not the driver, at step 514, the process 500 ends without activating the gaze-monitoring system. If the occupant is the driver, at step 510, the gaze-monitoring system is activated for use. If the occupant is not recognized at step 508, then at step 512 the gaze-monitoring system queries the occupant to determine if the gaze-monitoring system should be activated. In some embodiments the query may be in the form of a question displayed on the infotainment center display seeking input from the occupant using the touch-sensitive display. If the occupant indicates that they do not want the gaze-monitoring system activated, then the process 500 ends without activating the gaze-monitoring system at step 514. If the occupant indicates that they want the gaze-monitoring system activated, then at step 516 the gaze-monitoring system assigns the occupant a default profile. Next, at step 518, the gaze-monitoring system performs a calibration (see FIG. 9) for the vehicle occupant. Following calibration, at step 510 the gaze-monitoring system is activated for use.

As discussed below, the calibration data may be saved to the assigned default profile and the profile stored as a new profile for later use by the same occupant. In some embodiments, any vehicle occupant with the ability to enter and start the vehicle as a driver may be offered the option to activate the gaze-monitoring system, have a default profile assigned, have that default profile personalized, and have the personalized for later use. In some embodiments, when a vehicle occupant who has the ability to enter and start the vehicle as a driver is in the vehicle with other vehicle occupants, those other vehicle occupants may be offered the option to have default profiles assigned, have their respective default profiles personalized, and have the personalized profiles for later use. In some embodiments, the vehicle occupant who has access to and can start the vehicle may need to provide permission to other occupants before the other occupants are able to use the gaze-monitoring system. Such permission may be in the form of providing a settled gaze from the driver's seat at a predetermined vehicle component so that the gaze-monitoring system may identify the consent of the driver through consent of action or through facial recognition. In some embodiments, the driver may be given control of the gaze-monitoring system to the extent that the driver's gaze control may override the gaze control of passengers. In such embodiments, this may be included as a safety feature for the vehicle and all occupants of the vehicle.

In some embodiments, profiles may be maintained for vehicle occupants to make use of the gaze-monitoring system more convenient. In addition to calibration information, a profile may include other information provided by the vehicle occupant (e.g., name, age, height, relationship to other vehicle occupants, an image of the occupant's face and/or digital facial recognition data, etc.), which can help provide a personalize interface between the vehicle occupant and the gaze-monitoring system. Having an image of the occupant's face and/or digital facial recognition data enables the gaze-monitoring system to recognize vehicle occupants and determine if they already have a profile saved in the storage. In some embodiments, vehicle occupants may supply a personal code, using the infotainment center display, to aid the gaze-monitoring system in determining if they already have a profile. In some embodiments, vehicle occupants may select their profile from a list of profiles displayed on the infotainment center display. In embodiments in which vehicle occupants identify themselves, and thus their profiles, to the gaze-monitoring system interactively (as opposed to through facial recognition, which is passive identification), the vehicle occupants may also be asked to indicate where they are seated in the vehicle.

Profiles may also offer vehicle occupants the ability to set preferences to be used while the vehicle occupant is in the vehicle. For example, the profile may offer an easy way for the vehicle occupant to indicate if they are an owner of the vehicle, to select favorite or preferred music, podcasts, or other audio entertainment, to set maximum volumes for the music, to set preferred temperatures for the climate control system, to set a preferred seat position, to set preferred driver assist settings (e.g., lane awareness, adaptive cruise control, and the like), and to set preferences for information and systems displayed on the driver display and on the infotainment center display. In some embodiments, profiles may provide a vehicle owner or driver gaze control priority over the gaze control of non-owner vehicle occupants. Such priority may also be offered to owners or drivers over select vehicle systems (e.g., the sound system). In some embodiments, the preferences of an owner may be given priority over the preferences of a non-owner driver. In some embodiments, profiles may also provide easy conflict resolution when conflicting gaze control arises from multiple vehicle occupants. In some embodiments, such conflicts may be generally resolved in favor of the driver, and such resolution may be based on preferences in the driver's profile.

Profiles may also include data relating to the vehicle occupant's use of the gaze-monitoring system over time. For example, data relating a vehicle occupant's use of the gaze-monitoring system may be analyzed by the gaze-monitoring system. In some embodiments, the gaze-monitoring system may utilize an external data analysis agent (e.g., the server 318 of FIG. 3) to analyze collected the usage data. In such embodiments, the gaze-monitoring system may use machine learning to analyze the data, and the machine learning algorithms may identify habits of the vehicle occupant when using the vehicle with the gaze-monitoring system. The identified habits a vehicle occupant may thereafter be incorporated into the profile of that vehicle occupant for later use by the gaze-monitoring system.

In some embodiments, the information and data saved as part of a vehicle occupant's profile may be considered as gaze context. Moreover, data in a profile may remain as gaze context until the data is changed or deleted from the profile. The data in a profile may, therefore, be an overarching type of gaze context because of the potential wide application and potential long duration as gaze context. For example, if a vehicle occupant is the driver and their profile includes a preference for a maximum cabin temperature of 68° F. (20° C.) for the climate control system, then the gaze-monitoring system may interpret that profile preference as part of the gaze context for gazes from that vehicle occupant. Moreover, when that vehicle occupant is the driver, the gaze-monitoring system may also use that profile preference (of the driver) as part of the gaze context for gazes from other vehicle occupants. In one scenario based on this example, if the vehicle occupant has included such a maximum cabin temperature preference in their profile, then the gaze-monitoring system may not increase the target cabin temperature above the maximum cabin temperature indicated in the profile. This means that even if the vehicle occupant's gaze settles on the climate control UI displayed on the infotainment center display while the cabin temperature sensor indicates the cabin temperature is 68° F. (20° C.) and an external temperature sensor indicates the outside temperature is 32° F. (0° C.), which may be gaze context that might otherwise be interpreted to indicate that the vehicle occupant is cold, the gaze-monitoring system may not increase the cabin temperature. This is because the profile preference also serves as a gaze context for all gazes relating to temperature, and since from the driver's profile the cabin temperature gaze context indicates that 68° F. (20° C.) is a maximum cabin temperature, the gaze-monitoring system will not raise the target cabin temperature above that preference maximum.

In a similar scenario, the same vehicle occupant is the driver and another vehicle occupant is in the front passenger seat. If the passenger's gaze settles on the climate control UI under the same cabin temperature and external temperature in the preceding example, the gaze-monitoring system may still not increase the cabin temperature despite the gaze control attempt coming from a different vehicle occupant. This is because the driver's profile preferences may be considered as gaze context for all passengers within the vehicle, and where a passenger attempts (even unknowingly) to go to control any vehicle system or component in a range that conflicts with the driver's profile preferences, then the driver's profile preferences may be strictly adhered to by the gaze-monitoring system.

In some embodiments, vehicle occupant profiles may include inferred or explicitly established user preferences. Vehicle occupant profiles may include preferences relating to any one or more of: cabin temperatures, seat position and/or heating settings, navigation routes (e.g., avoid toll roads), favorite destinations, audio media (e.g., radio stations, audio apps or services, playlists, podcast shows or episodes, audio books, playback progress, etc.), driver assist settings for driving (e.g., lane awareness on/off, adaptive cruise control distance, etc.), display arrangements for HUDs and infotainment centers, and other settings that may be used during vehicle operation. In some embodiments, a vehicle occupant may selectively enable or disable gaze control for different vehicle components or systems in response to predetermined contexts identified in the vehicle occupant's profile. In some embodiments, a vehicle occupant may selectively enable or disable gaze control for other passengers of the vehicle, even the gaze-monitoring system is active for the other passengers. For example, a parent may have their profile set with a preference indicating their child should not have control over the sound system or the climate control system. As another example, a driver may have their profile set to indicate that no passenger should be permitted to play heavy metal music in the vehicle.

In some embodiments, the gaze-monitoring system may disable different input interfaces to help avoid distracted driving when multiple vehicle occupants are gazing out the windows in the same direction or when the vehicle is in heavy traffic. More than one vehicle occupant staring in the same direction or at the same vehicle component (e.g., the infotainment center display) may be a strong gaze context for indicating distractedness, and the response of the gaze-monitoring system may be determined by the severity of the distraction. The gaze-monitoring system may also re-enable the input interfaces once driving conditions have returned to ordinary safe conditions. In such instances, the gaze-monitoring system may deactivate voice, gaze, or touch interfaces in response to one or more occupants looking out the window for an extended period and determining the gaze context of vehicles or people on or near the road indicating potentially hazardous nearby circumstances. As another example, the gaze-monitoring system may deactivate the voice command system (for the driver and/or for other vehicle occupants) when the driver's gaze is on the road and the gaze context is the driver receiving a phone call. Deactivation of the voice command system, in this circumstance, may be a safety feature to help prevent too many driving distractions at one time. As another example, the gaze-monitoring system may temporarily deactivate gaze control for the driver when the driver's gaze is on the road and the gaze context is hazardous road conditions (e.g., rain, low visibility, heavy traffic, etc.) Deactivation of the voice command system, in this circumstance, may also be a safety feature to encourage the driver to pay close attention to the road and driving conditions. In such a scenario, the gaze-monitoring system may keep gaze control active for other passengers in the vehicle.

In some embodiments, the gaze-monitoring system may take alternative actions during distracted driving. Potential responses by the gaze-monitoring system may include turning on hazard lights, generating an audible or visible alert within the cabin, change sensitivities for safety features (e.g., increase the set point distance used for automatic braking), and the like. These safety-related options may be enabled using profiles. In some embodiments, vehicle occupants may not be provided with the option to turn off such safety features.

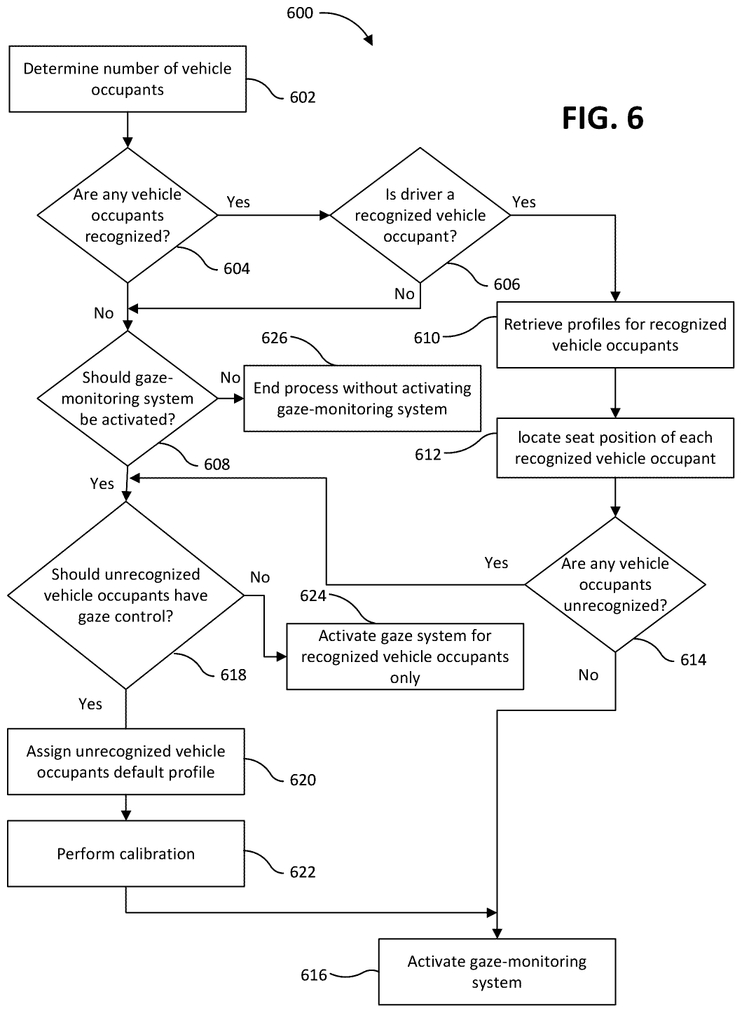

FIG. 6 shows a flowchart illustrating the steps of a process 600 for initializing a gaze-monitoring system upon start-up of a vehicle. The process 600 may be implemented on the systems discussed herein and similar systems for monitoring a vehicle occupant's gaze and controlling a vehicle component based on the gaze and a gaze context. One or more actions of the process may be incorporated into or combined with one or more actions of any other process or embodiment described herein. At step 602, the gaze-monitoring system determines the number of vehicle occupants in the vehicle using the optical sensors, and at step 604, the gaze-monitoring system determines if any of the vehicle occupants are recognized. If at least one vehicle occupant is recognized at step 604, then at step 606 the gaze-monitoring system determines if the driver is a recognized occupant. If no vehicle occupants are recognized at step 604 or if the driver is not a recognized occupant at step 606, then at step 608 the gaze-monitoring asks for input from the vehicle occupants to determine whether the gaze-monitoring system should be activated. If the vehicle occupants indicate the gaze-monitoring system should not be activated, at step 626 the process 600 is terminated without activating the gaze-monitoring system. If the vehicle occupants indicate that the gaze-monitoring system should be activated, then the gaze-monitoring system is proceeds with calibration for each vehicle occupant (see FIG. 9). Following calibration, at step 616 the gaze-monitoring system is activated. If at step 606 the driver is a recognized occupant, then at step 610 the gaze-monitoring system retrieves profiles for the recognized vehicle occupants from the storage. At step 612, the gaze-monitoring system identifies the seat position within the vehicle of each recognized vehicle occupant. At step 614, the gaze-monitoring system determines if any vehicle occupants remain unrecognized, and if there are no unrecognized vehicle occupants, the gaze-monitoring system is activated at step 616.

If there are unrecognized vehicle occupants, at step 618 the gaze-monitoring system asks the driver if the unrecognized vehicle occupants should be granted gaze control. The driver may provide input to the gaze-monitoring system using the infotainment center display. In some embodiments, controls or buttons may be located on the steering wheel, and such controls or buttons may be temporarily configured so that the driver may provide input to the gaze-monitoring system utilizing those controls or buttons. If the driver indicates that the unrecognized vehicle occupants should not be granted gaze control, at step 624 the gaze-monitoring system is activated for the recognized vehicle occupants only. If the driver indicates that the unrecognized vehicle occupants should be granted gaze control, at step 620 default profiles are assigned to unrecognize occupants, and at step 622 calibration proceeds for each unrecognized vehicle occupant (see FIG. 9). Following calibration, at step 616 the gaze-monitoring system is activated.

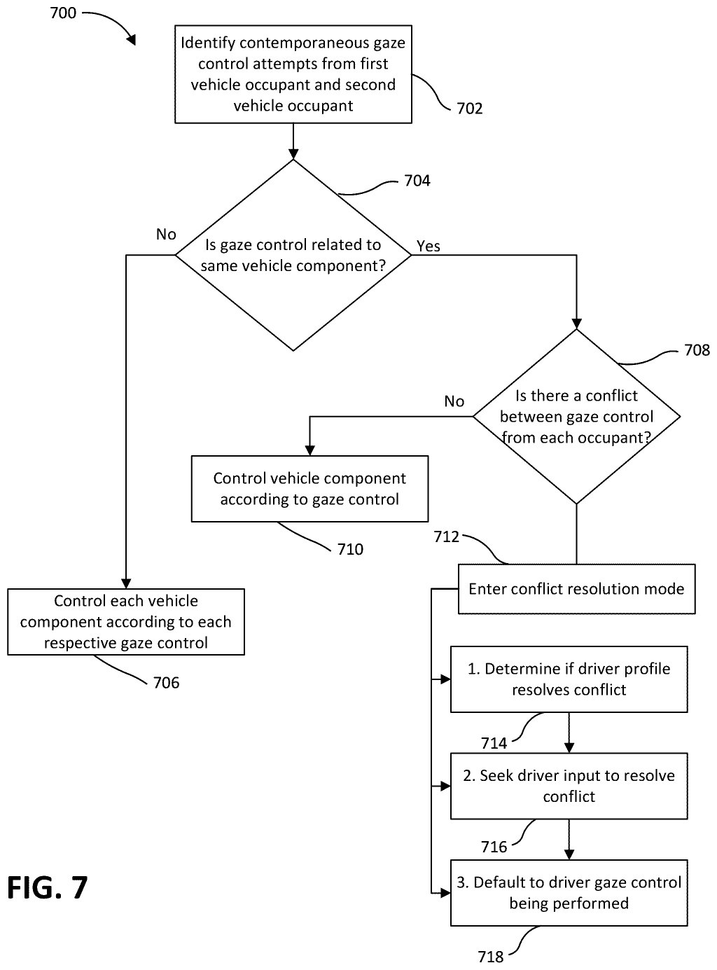

FIG. 7 shows a flowchart illustrating the steps of a process 700 for gaze control conflict resolution incorporated into a gaze-monitoring system. The process 700 may be implemented on the systems discussed herein and similar systems for monitoring a vehicle occupant's gaze and controlling a vehicle component based on the gaze and a gaze context. One or more actions of the process may be incorporated into or combined with one or more actions of any other process or embodiment described herein. At step 702, the gaze-monitoring system identifies contemporaneous gaze control attempts from a first vehicle occupant and a second vehicle occupant. At step 704, the gaze-monitoring system determines if both gaze control attempts relate to the same vehicle component. If each gaze control attempt relates to control of different vehicle components, at step 706 each vehicle component is controlled according to each respective gaze control. If each gaze control attempt relates to control of the same vehicle component, at step 708 the gaze-monitoring system determines if there is a conflict between the gaze control attempts from each vehicle occupant. If there is no conflict, at step 710 the vehicle component is controlled according to each respective gaze control. If there is a conflict (e.g., one vehicle occupant is seeking to use gaze control to turn up the music volume, while the other vehicle occupant is seeking to use gaze control to turn down the music volume), at step 712 the gaze-monitoring system enters conflict resolution mode. In conflict resolution mode, at step 714, the gaze-monitoring system may first refer to the driver's profile to determine if the driver's profile provides gaze context that resolves the conflict. If the driver's profile can resolve the conflict, then the driver's profile is utilized as gaze context for one or both of the vehicle occupant's gaze control attempts to resolve the conflict. At step 716, the gaze-monitoring system may next seek input from the driver to resolve the conflict. As part of this step, the conflict may be described to the driver using the infotainment center display, and the driver may be asked to provide input to resolve the conflict. The driver may provide the input through the touch-sensitive display or by voice and/or utilizing buttons on the steering wheel to provide input to the gaze-control system to resolve the conflict. In the event the driver does not provide input to resolve the conflict, at step 718 the gaze-monitoring system may next default to the driver's gaze control being performed and ignoring the gaze control of the other vehicle occupant. In some embodiments, a user profile may be used for conflict resolution based at least in part on, e.g., identifying the driver.

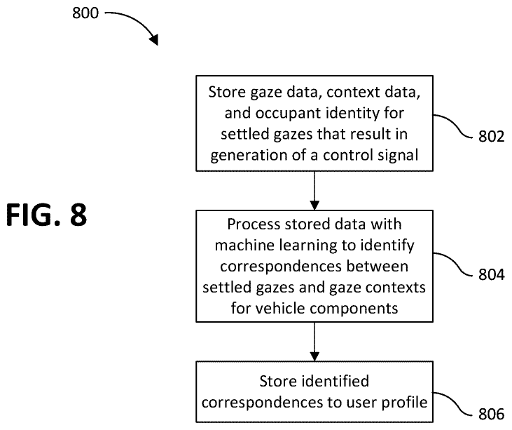

FIG. 8 shows a flowchart illustrating the steps of a process 800 for machine learning as part of a gaze-monitoring system. The process 800 may be implemented on the systems discussed herein and similar systems for monitoring a vehicle occupant's gaze and controlling a vehicle component based on the gaze and a gaze context. One or more actions of the process may be incorporated into or combined with one or more actions of any other process or embodiment described herein. At step 802, the gaze-monitoring system stores gaze data, context data, and occupant identity for settled gazes that result in generation of control signals for vehicle components. At step 804, the gaze-monitoring system processes the stored data with machine learning to identify correspondences between settled gazes and gaze contexts for vehicle components. In some embodiments, machine learning is performed in data batched by vehicle occupant, as in doing so the output of the machine learning is more likely to be beneficial to each individual vehicle occupant. At step 806, correspondences that are identified by the machine learning process are stored as part of the profile for the vehicle occupant from whom the analyzed data originated. This machine learning process may be performed to identify the habits of a vehicle occupant based on historical actions of that vehicle occupant. In some embodiments, the machine learning processing may be performed by the control circuity integrated into the vehicle as part of the gaze-monitoring system. In some embodiments, the gaze-monitoring system may delay the machine learning processing until a time when the vehicle is not being driven, at which time the data may be communicated to a server for machine learning processing. In some embodiments, the server and the gaze-monitoring system may perform the machine learning process in a distributed manner.

The machine learning process may be based on a neural network model. As is common with neural network models, the model is initially trained using training data so that the model can learn about the data, data types, and other factors that may impact the output of the model. While it would take a single vehicle occupant lots of driving to develop sufficient data to train the neural network model, the initial training data may be collected from multiple drivers over time so that the model learns about the data, data types, and resulting actions by the gaze-monitoring system (and even non-actions) from a larger data set. Following the initial training, the model may be implemented for individual drivers and vehicle occupants to begin learning more about their gaze control histories and identifying their habits. Outputs from the model may be incorporated into the profile of a vehicle occupant so that over time, the gaze-monitoring system becomes more responsive to the individual habits and patterns of individual vehicle occupants. In some embodiments, owners of a vehicle may choose to make this machine learning processing of data available only to owners or regular drivers of the vehicle.

FIG. 9 shows a flowchart illustrating the steps of a process 900 for calibrating a gaze-monitoring system for use with an unrecognized vehicle occupant. The process 900 may be implemented on the systems discussed herein and similar systems for monitoring a vehicle occupant's gaze and controlling a vehicle component based on the gaze and a gaze context. One or more actions of the process may be incorporated into or combined with one or more actions of any other process or embodiment described herein. At step 902, The gaze-monitoring system determines the position of the seat in which the unrecognized vehicle occupant is seated. This step may be performed by receiving data from motorized seat positioning system. In scenarios in which the unrecognized vehicle occupant is seated in the rear seat, step 902 may be skipped. At step 904, using the image sensors the gaze-monitoring system determines if the vehicle occupant is wearing head wear. This determination may be based on whether the image sensors have a clear view of the vehicle occupant's eyes. If the vehicle occupant is wearing head wear, at step 906 the vehicle occupant may be presented with a message on the infotainment center display requesting that they remove their head wear. At step 908, the gaze-monitoring system determines the vehicle occupant's eye level based on the seat position and background features of the vehicle cabin. At step 910, the gaze-monitoring system determines a coarse calibration for the vehicle occupant's eye tracking based on the eye level of the vehicle occupant and the determined position of the seat (for front seats only).

At step 912, the gaze-monitoring system instructs the occupant to gaze at displayed calibration targets. In the front seats, the calibration targets may be displayed on the infotainment center display. In some embodiments, the calibration targets may include several different vehicle components within the vehicle cabin. In the rear seats, in vehicles that include rear seat entertainment screens, the calibration targets may be displayed on the rear seat entertainment screens. In scenarios in which the vehicle does not include any rear seat entertainment screens, the gaze-monitoring system may include audible instructions for the vehicle occupant to look at specified vehicle components within the vehicle cabin. At step 914, the gaze-monitoring system tracks the eyes of the vehicle occupant as they look at the calibration targets. At step 916, the gaze-monitoring system determines if the eye tracking/gaze monitoring is sufficiently calibrated. In some embodiments, sufficient calibration may be determined by comparing an anticipated eye position with the actual measured eye position based on the last several displayed calibration targets. If the gaze-monitoring system determines that the gaze monitoring is not sufficiently calibrated, then the process returns to step 912. If the gaze-monitoring system determines that the gaze monitoring is sufficiently calibrated, then the process continues.

At step 918, the gaze-monitoring system identifies the vehicle occupant (by a name or nickname provided or by assigning an identification to the vehicle occupant) and saves the identity to a default vehicle occupant profile. At step 920, the gaze-monitoring system saves the gaze calibration data to the vehicle occupant profile. And at step 922, the gaze-monitoring system saves the seat position and location and the vehicle occupant's relative eye level to the vehicle occupant profile. The seat position and location and the relative eye level are saved to the vehicle occupant's profile to provide reference points that may be used to determine the vehicle occupant's eye level in the other seats in the vehicle. By knowing the seat position and location with respect to the image sensor used to perform the calibration, and by knowing the position and location of other seats in the vehicle with respect to the image sensor that is used for monitoring gaze in those other seats, the gaze-monitoring system may determine with fair accuracy what the eye level of the vehicle occupant would be in those other seats in the same vehicle. However, if the vehicle occupant is having trouble with gaze control in another seat within the vehicle, the vehicle occupant may repeat the calibration process when in a different seat.

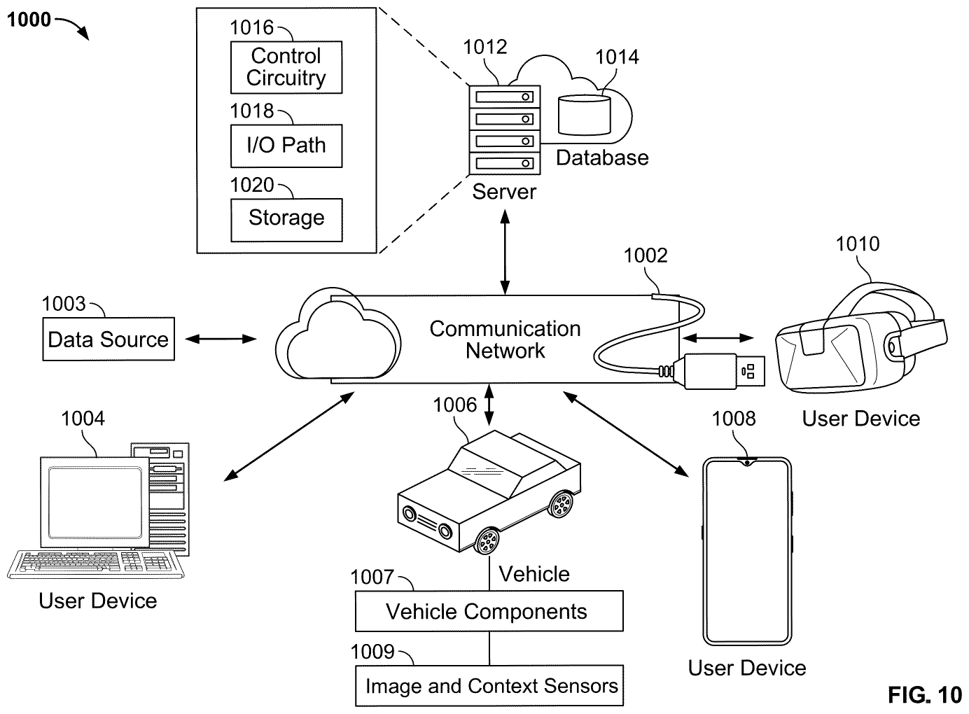

FIG. 10 is an example of an illustrative system implementing the user equipment device, in accordance with embodiments of the disclosure. A user equipment device utilizing at least some of the system features described above in connection with FIG. 10 may not be classified solely as vehicle 1006 or a user device 1004, 1008, 1010. For example, features and settings of vehicle 1006 may be remotely controlled via user devices 1004, 1008, 1010.

The user equipment devices may be coupled to communication network 1002. Communication network 1002 may be one or more networks including the internet, a mobile phone network, mobile voice or data network (e.g., a 4G, 5G or LTE network), a vehicle-to-vehicle (V2V) network, or other types of communication networks or combinations of communications networks.

System 1000 may comprise data source 1003, one or more servers 1012, and/or one or more edge computing devices. In some embodiments, the application may be executed at one or more of control circuitry 1016 of server 1012 (and/or control circuitry of user equipment 1004, 1006, 1008, 1010 and/or control circuitry of one or more edge computing devices). Communications with the data source 1003 and the user equipment devices may be exchanged over one or more communication paths. In some embodiments, the user equipment devices exchange communications with the computer equipment of other nearby vehicles over one or more communication paths. In some embodiments, the data source 1003 and/or server 704 may be configured to host or otherwise facilitate communication sessions between user equipment 1004, 1006, 1008, 1010 and/or any other suitable user equipment, and/or host or otherwise be in communication (e.g., over communication network 1002) with one or more network services.

In some embodiments, server 1012 may include control circuitry 1016 and storage 1020 (e.g., RAM, ROM, Hard Disk, Removable Disk, etc.). Storage 1020 may store one or more databases. Server 1012 may also include an I/O path 1018. In some embodiments, I/O path 1018 is an I/O circuitry. I/O circuitry may be, e.g., a NIC card, audio output device, mouse, keyboard card, any other suitable I/O circuitry device or combination thereof. I/O path 1018 may provide vehicle data, device information, or other data, over a local area network (LAN) or wide area network (WAN), and/or other content and data to control circuitry 1016, which may include processing circuitry, and storage 1020. Control circuitry 1016 may be used to send and receive commands, requests, and other suitable data using I/O path 1018, which may comprise I/O circuitry. I/O path 1018 may connect control circuitry 1016 to one or more communications paths.

Control circuitry 1016 may be based on any suitable control circuitry such as one or

more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 1016 may be distributed across multiple separate processors or processing units, for example, multiple of the same type of processing units (e.g., two Intel Core i7 processors) or multiple different processors (e.g., an Intel Core i6 processor and an Intel Core i7 processor). In some embodiments, control circuitry 1016 executes instructions for an emulation system application stored in memory (e.g., the storage 1020). Memory may be an electronic storage device provided as storage 1020 that is part of control circuitry 1016. Memory may store instruction to run the application.

Data source 1003 may include one or more types of content distribution equipment including a media distribution facility, satellite distribution facility, programming sources, intermediate distribution facilities and/or servers, internet providers, on-demand media servers, and other content providers. In some embodiments, the user equipment devices access the data source 1003 to receive color programming data. In some approaches, data source 1003 may be any suitable server configured to provide any information needed for operation of the user equipment devices as described above and below (e.g., in FIGS. 1-9). For example, data source 1003 may provide weather information, environment information, data about vehicle capabilities, and/or any other suitable data needed for operations of user equipment devices (e.g., as described in FIGS. 1-9). In some implementations, color programming data may be provided to the user devices 1004, 1008, 1010 or vehicle 1006 from the data source 1003, which can be done using any suitable approach (e.g., a client/server approach). For example, the user equipment devices may pull content data from a server, or a server may present the content data to the user equipment devices. Data source 1003 may provide the user equipment devices the color programming application itself or software updates for the color programming application.

Although communications paths are not drawn between user equipment, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The user equipment may also communicate with each other directly through an indirect path via communication network 1002.

In some embodiments, such as system 1000, user equipment devices, may communicate over the communication network 1002 with a server 1012 to send and receive vehicle diagnostic data (e.g., data related to the vehicle's performance and internal systems, safety-related data (e.g., data related to vehicle speed or braking, especially in the event of a collision), GPS and map data, trained machine learning models the user equipment devices implements (e.g., analyzing external environment, or processing images), stored active vehicle surface color patterns, and any other necessary data. In some approaches, the user equipment devices send data (e.g., data collected from vehicular sensors or saved color patterns) back to server 1012, which server 1012 stores in database 1014. The process of sending vehicle data to and receiving vehicle data from a server is further described in FIG. 8. In some embodiments, server 1014 may incorporate and/or collaborate with one or more other servers e.g., server 318 from FIG. 3.

Vehicle 1006 may also include vehicle components 1007 and/or image and context sensors 1009. For instance, vehicle components 1007 may include climate control system, infotainment system, turn signals, cruise control, windshield wipers, rearview mirror, rear window defogger, door locks, windows controls, sunroof controls, adjustable seats, seat heaters, interior lights, and other vehicle components. In some embodiments, image and context sensors 1009 may comprise, e.g., diver image sensors, from passenger image sensors, rear passenger image sensors, speedometers, accelerometers, fuel/energy levels, window controls, sunroof controls, climate systems, infotainment systems, windshield sensors, rear window sensors, microphones, occupant image sensors, driving cameras, RADAR/LIDAR, external temperature sensors, cabin temperature sensors, and various other sensors. In some embodiments, user equipment devices include control circuitry, I/O circuitry, and storage similar to, e.g., control circuitry 302, I/O circuitry 306, and storage 304 from FIG. 3.

The systems and methods described herein present the advantage that the gaze context may enable an understanding of the intent of a vehicle occupant's gaze, and with an understanding of the vehicle occupant's intent, the gaze-monitoring system may control a vehicle component in response to vehicle occupant's gaze in a manner that is aligned with the intent of the vehicle occupant. As described herein, the gaze context may be based on data gathered from context sensors (temperature sensors, road sensors, etc.), the status of other vehicle systems (sound system, climate control system, etc.), vehicle occupant profile information (preferences, habits data, etc.), and from various other contextual information (the profiles of other vehicle occupants, the status of other vehicle occupants, etc.). For example, a vehicle occupant may gaze up at the sunroof controls and the gaze-monitoring system may determine contemporaneous gaze context from (i) the temperature external to the vehicle is temperate (and not raining), and/or (ii) historical data indicating the vehicle occupant likes to open the sunroof in such driving conditions. Based on this gaze and/or gaze context, the gaze-monitoring system may open the sunroof. Moreover, if the historical data indicates the vehicle occupant tends to drive with the sunroof half open, the gaze-monitoring system may open the sunroof only halfway.

In another example, the driver of a vehicle may make multiple sequential gazes in a short period toward the driver side mirror. The gaze-monitoring system may detect these multiple sequential gazes and determine that the prior gazes in the sequence serve as gaze context to identify one of the subsequent gazes as settled, and therefore actionable. The gaze-monitoring system may determine from the navigation system a gaze context that the driver will need to change lanes to follow the navigation route. In response, the gaze-monitoring system may notify the driver if another vehicle is located in the driver's blind spot before the driver uses the turn signals or even begins to change lanes.

In another example, a vehicle occupant may gaze at the climate control system interface, and the gaze context indicates the ambient cabin temperature is cold. The gaze-monitoring system may respond by inferring that the vehicle occupant is cold and increasing the set point temperature of the climate control system. In other scenarios relating to the climate control system, the gaze-monitoring system may use external environmental conditions as gaze context. For example, when a vehicle occupant gazes at the climate control system interface and the gaze context is a hot external temperature, the gaze-monitoring system may respond by decreasing the set point temperature of the climate control system.

In another example, while the driver's gaze is on the road, the gaze-monitoring system may detect the gaze context of other passengers falling asleep or being asleep (e.g., eyes detected as being closed, little to no body movements detected, lack of sound detected from the passengers, no recent interactions detected with vehicle systems, etc.). Since the general intent of a driver is to stay awake, the gaze-monitoring system may monitor the driver's gaze more aggressively for warnings of fatigue and to activate alarms more aggressively in the event the gaze-monitoring system detects the driver is becoming drowsy. Another potential response by the gaze-monitoring system in this scenario would be to reduce the set point temperature of the climate control system.

In some embodiments, the gaze-monitoring system may detect the driver gazing at the infotainment center display for an extended period (e.g., over 2 seconds), and with a substantial road speed or heavy traffic conditions as context, the gaze-monitoring system may respond by turning off the display or blinking the display to remind the driver to pay attention to the road and vehicle surroundings.

In some embodiments, the gaze-monitoring system may detect a non-driver passenger gazing at a blank display, with the gaze exceeding a predetermined time (e.g., 2 seconds), and with the blank display as gaze context, gaze-monitoring system may activate the display. Similarly, if a display is on and a passenger has not looked at the display after a predetermined time (e.g., 5 minutes), the gaze-monitoring system may turn the display off.

The processes described above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods. Throughout the specification the phrases “in response to” and “based on” shall be understood to have a broad meaning unless context requires otherwise. For example, “in response to” can refer to a step that is in direct or indirect response to a prior step, and “based on” can refer to a step that is based at least in part on a prior step.

1. A method of controlling vehicle components comprising:
monitoring, using one or more optical sensors and control circuitry, a first gaze of a first vehicle occupant to identify a first settled gaze;
determining, using one or more context sensors and the control circuitry, a first gaze context occurring contemporaneously with a first settled gaze;
identifying, using the control circuitry, a first vehicle component based on the first settled gaze and the first gaze context; and
generating, at input/output circuitry, a control signal to control the first vehicle component, the control signal based on the first vehicle component and the first gaze context.

2. The method of claim 1, further comprising determining that the first settled gaze is directed towards the first vehicle component.

3. The method of claim 1, further comprising determining that the first settled gaze is directed towards a second vehicle component associated with the first vehicle component.

4. The method of claim 1, further comprising determining that the first settled gaze is directed towards a predetermined direction.

5. The method of claim 1, further comprising determining the first gaze context based on a first occupant profile associated with the first vehicle occupant.

6. The method of claim 5, wherein the first occupant profile comprises occupant habits data based on historical actions of the first vehicle occupant.

7. The method of claim 1, further comprising determining the first gaze context based on an event detected by the one or more context sensors.

8. The method of claim 1, further comprising determining the first gaze context based on a sound detected by the one or more context sensors.

9. The method of claim 1, further comprising determining the first gaze context based on one or more spoken words detected by the one or more context sensors.

10. The method of claim 1, further comprising determining the first gaze context based on a vehicle sub-system status.

11. The method of claim 1, further comprising determining the first gaze context based on one or more objects detected external to the vehicle using the one or more context sensors.

12. The method of claim 1, further comprising determining the first gaze context based on a second gaze by the first vehicle occupant, the second gaze preceding the first settled gaze.

13. The method of claim 1, further comprising:
determining, using the optical sensor and the control circuitry, a first occupant profile of the first vehicle occupant; and
determining, using the optical sensor and the control circuitry, a second occupant profile of a second vehicle occupant.

14. The method of claim 13, further comprising identifying one of the first vehicle occupant and the second vehicle occupant as a driver occupant, and the other of the first vehicle occupant and the second vehicle occupant as a passenger occupant.

15. The method of claim 13, wherein one of the first occupant profile and the second occupant profile comprises a default occupant profile.

16. The method of claim 13, wherein the first gaze context is based on the first occupant profile and the second occupant profile.

17. The method of claim 13, further comprising determining the first gaze context based on an authorization priorities indicator between the first occupant profile and the second occupant profile.

18. A system to control vehicle components comprising:
input/output circuitry;
a first optical sensor;
one or more context sensors; and
control circuitry configured to:
monitor, using the one or more optical sensors, a gaze of a first vehicle occupant to determine a first settled gaze;
determine, using the one or more context sensors, a first gaze context occurring contemporaneously with the first settled gaze;
identify a first vehicle component based on the first settled gaze and the first gaze context; and
generating, at the input/output circuitry, a control signal to control the first vehicle component, the control signal based on the first vehicle component and the first gaze context.

19. The system of claim 18, wherein the control circuitry is configured to determine that the first settled gaze is directed towards the first vehicle component.

20. The system of claim 18, wherein the control circuitry is configured to determine that the first settled gaze is directed towards a second vehicle component associated with the first vehicle component.

21-51. (canceled)
